(19) United States
(12) Patent Application Publication
(10) Pub. No.: US 2026/0094965 A1
(43) Pub. Date: Apr. 2, 2026

(54) ELECTRONIC DEVICE INCLUDING ANTENNA

(71) Applicant: Samsung Electronics Co., Ltd., Suwon-si (KR)

(72) Inventors: Cheungwon RYU, Suwon-si (KR); Eunbae KWON, Suwon-si (KR); Sanguk KIM, Suwon-si (KR); Jongmin KIM, Suwon-si (KR); Hyoseok NA, Suwon-si (KR); Jihwan OH, Suwon-si (KR); Gwanhui LEE, Suwon-si (KR); Jonghyeok JEON, Suwon-si (KR)

(73) Assignee: Samsung Electronics Co., Ltd., Suwon-si (KR)

(21) Appl. No.: 19/364,582

(22) Filed: Oct. 21, 2025

Related U.S. Application Data
(63) Continuation of application No. PCT/KR2025/015459, filed on Sep. 30, 2025.

(30) Foreign Application Priority Data
Sep. 30, 2024 (KR) 10-2024-0132714
Nov. 14, 2024 (KR) 10-2024-0161838

(51) Int. Cl. H01Q 5/20; H01Q 1/24

(52) U.S. Cl. CPC H01Q 5/20; H01Q 1/243

(57) ABSTRACT

An electronic device includes: a housing including a conductive portion including at least one opening; an antenna module including a substrate including a first substrate surface, and a plurality of antenna elements on the substrate to form a beam pattern, wherein the first substrate surface of the substrate faces the conductive portion so that a portion of the beam pattern formed by the plurality of antenna elements extends in a direction that passes through the at least one opening; a first wireless communication circuit to transmit or receive a wireless signal in at least one first frequency band through the antenna module; and a second wireless communication circuit to transmit or receive a wireless signal in at least one second frequency band through the conductive portion, wherein the first substrate surface of the substrate and an inner surface of the conductive portion are not parallel to each other.

### CROSS-REFERENCE TO RELATED APPLICATIONS

This application is a continuation of International Application No. PCT/KR2025/015459, filed on Sep. 30, 2025, which is based on and claims priority to Patent Application No. 10-2024-0132714, filed on Sep. 30, 2024, and Korean Patent Application No. 10-2024-0161838 filed on Nov. 14, 2024, in the Korean Intellectual Property Office, the disclosures of which are incorporated by reference herein in their entireties.

### BACKGROUND

### 1. Field

The present disclosure relates to an electronic device including an antenna.

### 2. Description of Relate Art

With the development of wireless communication technology, electronic devices (e.g., a portable communication device) are widely used in daily life, and thus the use of contents is increasing. Due to the rapid increase in the use of contents, the network capacity is gradually reaching a limit. After the commercialization of legacy communication systems, mmWave communication systems or new radio (NR) that transmit or receive signals using high-frequency (e.g., mm Wave) bands (e.g., 3 GHz to 300 GHz band) are being used together to satisfy the increasing demands for radio data traffic. Therefore, efficient disposition of legacy communication antennas and mmWave antennas may be required.

The information described above may be provided as the related art for the purpose of enhancing the understanding of the present disclosure. No assertion or determination is made with respect to the applicability of any of the above-mentioned as being prior art related to the present disclosure.

### SUMMARY

An electronic device may include an antenna module (e.g., antenna structure elements) including a substrate and a plurality of antenna elements (e.g., conductive patches and/or conductive patterns) that are disposed on the substrate and spaced apart from each other. Such an antenna module may operate as an mmWave antenna in a frequency band of approximately 3 GHz to 300 GHz. The antenna module may be disposed to radiate from the inside to the outside of the electronic device, such that a beam pattern having directionality is formed. For example, the antenna module may be disposed in an internal space of the electronic device, such that a directional beam pattern is formed toward the outside of the electronic device through a side surface of the electronic device.

The electronic device may include a lateral member that is formed of a conductive member for stiffness reinforcement and to form a graceful exterior, and formed as at least a portion of the side surface of the electronic device. Such a lateral member may be segmented (electromagnetically) through at least one non-conductive portion (e.g., polymer), and may include at least one conductive portion electrically connected to a wireless communication circuit. The at least one conductive portion may operate as a legacy antenna in a frequency band of approximately 600 MHz to 6000 MHz.

For achieving compact size and slimness of the electronic device and efficient disposition of electric structures, the mmWave antenna may be disposed proximal to the conductive portion used as the legacy antenna. In such a case, a beam pattern formed from the mmWave antenna may be formed on the conductive portion and configured to be radiated to the outside of the electronic device through at least one opening filled with a non-conductive member (e.g., polymer). As the mmWave antenna is disposed more proximal to the conductive portion, a distance to the at least one opening becomes closer and radiation efficiency may be improved.

In such a case, the legacy antenna may have reduced radiation performance due to unintended low shifting of an operating frequency band caused by the proximity of the mmWave antenna including conductive elements (e.g., ground of the substrate and/or conductive patches).

Various embodiments of the present disclosure can provide an electronic device including an antenna having a disposition structure capable of reducing radiation performance degradation of the legacy antenna, even when the mmWave antenna is disposed in close proximity.

According to various embodiments, an electronic device including an antenna having a disposition structure that may help improve radiation performance of the mmWave antenna while maintaining radiation performance of the legacy antenna can be provided.

However, the object to be achieved by the present disclosure is not limited to the above-mentioned objects but may be variously expanded without departing from the spirit and scope of the present disclosure.

### Solution to Problem

According an aspect of the disclosure, an electronic device may include: a housing including a conductive portion that forms at least a portion of a side surface of the housing and the conductive portion includes at least one opening; an antenna module in the housing and including: a substrate including a first substrate surface, and a plurality of antenna elements disposed at the substrate and configured to form a beam pattern in a direction in which the first substrate surface faces, wherein the first substrate surface of the substrate faces the conductive portion so that a portion of the beam pattern formed by the plurality of antenna elements extends in a direction that passes through the at least one opening; a first wireless communication circuit configured to transmit or receive a wireless signal in at least one first frequency band through the antenna module; and a second wireless communication circuit electrically connected to a feeding point of the conductive portion and configured to transmit or receive a wireless signal in at least one second frequency band through the conductive portion, wherein the substrate is tilted with respect to the conductive portion so that the first substrate surface of the substrate and an inner surface of the conductive portion are not parallel to each other.

An electronic device according to one or more embodiments of the present disclosure may include a proximal disposition structure in which a substrate of an mmWave antenna is disposed to be tilted so as not to be parallel to a conductive portion that is formed as a portion of a side surface of the electronic device and operates as a legacy antenna, so that radiation performance of the legacy antenna may be maintained, and helping to improve the radiation performance of the mmWave antenna.

In addition, various effects that can be directly or indirectly identified through the present document can be provided.

The effects obtained by the disclosure are not limited to the aforementioned effects, and other effects, which are not mentioned above, will be clearly understood by those skilled in the art from the following description.

### BRIEF DESCRIPTION OF THE DRAWINGS

In connection with the description of the drawings, the same or similar reference numerals may be used for the same or similar constituent elements.

FIG. 1 is a block diagram of an electronic device in a network environment according to various embodiments of the present disclosure;

FIG. 2 is a block diagram of an electronic device for supporting legacy network communication and 5G network communication according to various embodiments of the present disclosure;

FIG. 3A is a perspective view of a front surface of an electronic device according to various embodiments of the present disclosure;

FIG. 3B is a perspective view of a rear surface of the electronic device in FIG. 3a according to various embodiments of the present disclosure;

FIG. 3C is an expanded perspective view of the electronic device in FIG. 3B according to various embodiments of the present disclosure;

FIG. 4 is a perspective view illustrating a disposition structure of an antenna module and a conductive portion according to various embodiments of the present disclosure;

FIG. 5A is a configuration diagram illustrating a rear surface of an electronic device according to various embodiments of the present disclosure;

FIG. 5B is an enlarged view of a region 5b in FIG. 5A according to various embodiments of the present disclosure;

FIG. 5C is a diagram of the electronic device viewed along a direction 5c-5c of FIG. 5B according to various embodiments of the present disclosure;

FIGS. 6A and 6B are graphs comparing radiation performance of a second antenna depending on whether an antenna module of a first antenna is tilted when the antenna module is in close proximity to a conductive portion, according to various embodiments of the present disclosure;

FIGS. 7A and 7B are graphs comparing radiation performance of a second antenna depending on whether an antenna module of a first antenna is tilted when the antenna module is in close proximity to a conductive portion, according to various embodiments of the present disclosure;

FIG. 8A is a partial configuration diagram of an electronic device including a tilted antenna module according to various embodiments of the present disclosure;

FIG. 8B is a diagram of the electronic device viewed along a direction 8b-8b of FIG. 8A according to various embodiments of the present disclosure;

FIG. 9A is a partial configuration diagram of an electronic device including a tilted antenna module according to various embodiments of the present disclosure;

FIG. 9B is a diagram of the electronic device viewed along a direction 9b-9b of FIG. 9A according to various embodiments of the present disclosure; and

FIGS. 10A, 10B, and 10C are diagrams illustrating a disposition structure of a first antenna and a second antenna according to various embodiments of the present disclosure.

### DETAILED DESCRIPTION

Hereinafter, with reference to the drawings, various example embodiments of the disclosure will be described in greater detail so that those skilled in the art can readily carry out the embodiments. However, the disclosure may be implemented in various different forms and is not limited to the example embodiments described herein. In connection with the description of the drawings, the same or similar reference symbols may be used for identical or similar components. Additionally, in the drawings and related descriptions, descriptions of well-known functions and configurations may be omitted for clarity and brevity.

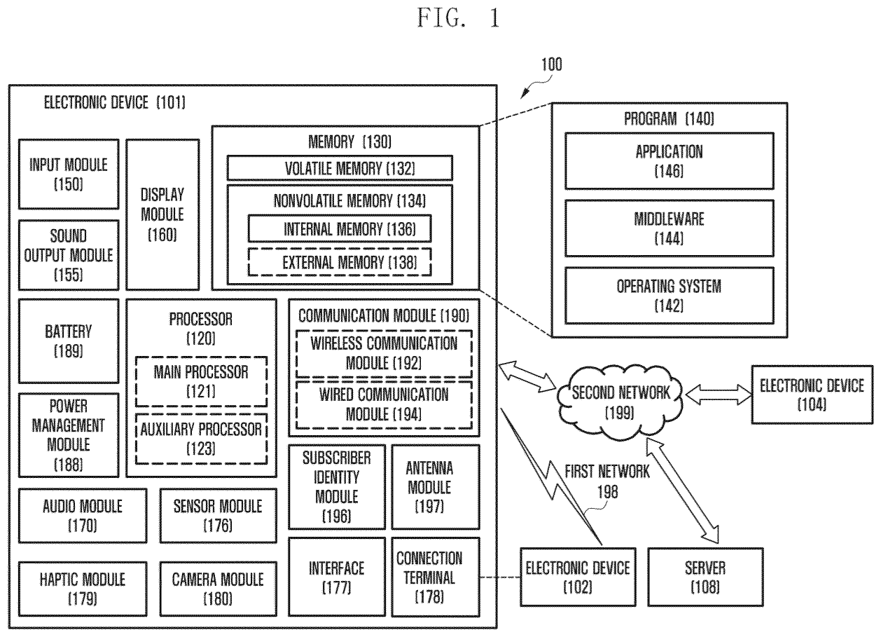

FIG. 1 is a block diagram illustrating an example electronic device in a network environment according to an embodiment of the disclosure.

Referring to FIG. 1, an electronic device 101 in a network environment 100 may communicate with an electronic device 102 via a first network 198 (e.g., a short-range wireless communication network), or an electronic device 104 or a server 108 via a second network 199 (e.g., a long-range wireless communication network). The electronic device 101 may communicate with the electronic device 104 via the server 108. The electronic device 101 includes a processor 120, memory 130, an input module 150, an audio output module 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In various embodiments, at least one (e.g., the display device 160 or the camera module 180) of the components may be omitted from the electronic device 101, or one or more other components may be added in the electronic device 101. In various embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. As at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. The processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). The auxiliary processor 123 (e.g., an ISP or a CP) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. the non-volatile memory 134 may include internal memory 136 and external memory 138.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, or a digital pen (e.g., a stylus pen).

The audio output module 155 may output sound signals to the outside of the electronic device 101. The audio output module 155 may include, for example, a speaker or a receiver. The speaker may be used for general purposes, such as playing multimedia or playing record, and the receiver may be used for incoming calls. The receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. The display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. The audio module 170 may obtain the sound via the input module 150, or output the sound via the audio output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. The sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. The interface 177 may include, for example, a high definition multimedia interface (HDMI), a universal serial bus (USB) interface, a secure digital (SD) card interface, or an audio interface.

A connection terminal 178 may include a connector via which the electronic device 101 may be physically connected with the external electronic device (e.g., the electronic device 102). The connection terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. The haptic module 179 may include, for example, a motor, a piezoelectric element, or an electric stimulator.

The camera module 180 may capture an image or moving images. The camera module 180 may include one or more lenses, image sensors, image signal processors, or flashes.

The power management module 188 may manage power supplied to the electronic device 101. The power management module 188 may be implemented as at least part of, for example, a power management integrated circuit (PMIC).

The battery 189 may supply power to at least one component of the electronic device 101. The battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the AP) and supports a direct (e.g., wired) communication or a wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

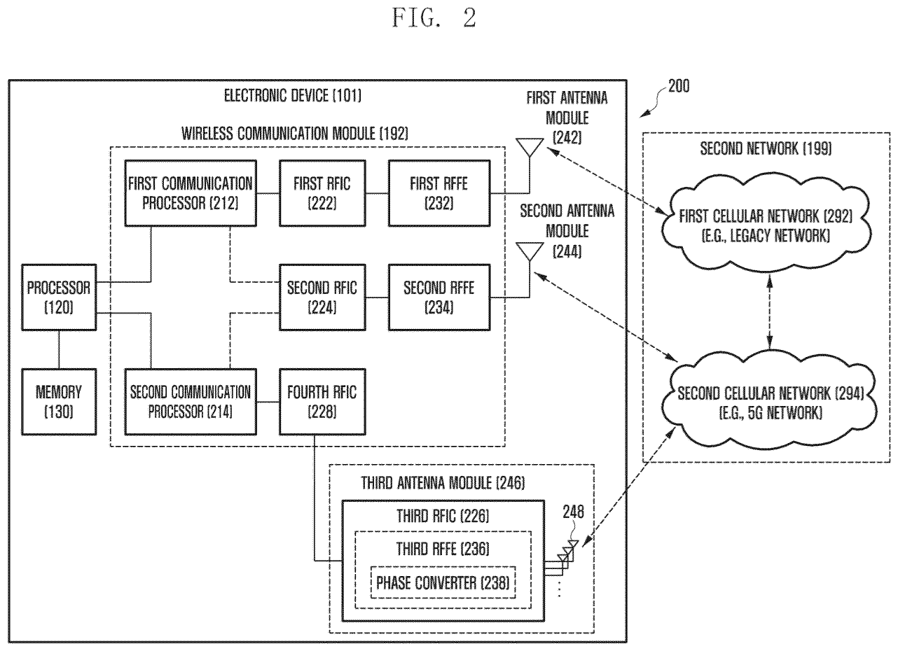

FIG. 2 is a block diagram illustrating an example configuration of an electronic device in a network environment including a plurality of cellular networks according to an embodiment of the disclosure.

Referring to FIG. 2, the electronic device 101 a network environment 200 may include a first communication processor (e.g., including processing circuitry) 212, second communication processor (e.g., including processing circuitry) 214, first RFIC 222, second RFIC 224, third RFIC 226, fourth RFIC 228, first radio frequency front end (RFFE) 232, second RFFE 234, first antenna module 242, second antenna module 244, and antenna 248. The electronic device 101 may include a processor 120 and a memory 130. A second network 199 may include a first cellular network 292 and a second cellular network 294. According to an embodiment, the electronic device 101 may further include at least one of the components described with reference to FIG. 1, and the second network 199 may further include at least one other network. According to an embodiment, the first communication processor 212, second communication processor 214, first RFIC 222, second RFIC 224, fourth RFIC 228, first RFFE 232, and second RFFE 234 may form at least part of the wireless communication module 192. According to an embodiment, the fourth RFIC 228 may be omitted or included as part of the third RFIC 226.

The first communication processor 212 may include various processing circuitry and establish a communication channel of a band to be used for wireless communication with the first cellular network 292 and support legacy network communication through the established communication channel. According to various embodiments, the first cellular network may be a legacy network including a second generation (2G), third generation (3G), 4G, or long term evolution (LTE) network. The second communication processor 214 may include various processing circuitry and establish a communication channel corresponding to a designated band (e.g., about 6 GHz to about 60 GHz) of bands to be used for wireless communication with the second cellular network 294, and support 5G network communication through the established communication channel. According to various embodiments, the second cellular network 294 may be a 5G network defined in third generation partnership project (3GPP). Additionally, according to an embodiment, the first communication processor 212 or the second communication processor 214 may establish a communication channel corresponding to another designated band (e.g., about 6 GHz or less) of bands to be used for wireless communication with the second cellular network 294 and support 5G network communication through the established communication channel. According to an embodiment, the first communication processor 212 and the second communication processor 214 may be implemented in a single chip or a single package. According to various embodiments, the first communication processor 212 or the second communication processor 214 may be formed in a single chip or a single package with the processor 120, the auxiliary processor 123, or the communication module 190.

Upon transmission, the first RFIC 222 may convert a baseband signal generated by the first communication processor 212 to a radio frequency (RF) signal of about 700 MHz to about 3 GHz used in the first cellular network 292 (e.g., legacy network). Upon reception, an RF signal may be obtained from the first cellular network 292 (e.g., legacy network) through an antenna (e.g., the first antenna module 242) and be preprocessed through an RFFE (e.g., the first RFFE 232). The first RFIC 222 may convert the preprocessed RF signal to a baseband signal so as to be processed by the first communication processor 212.

Upon transmission, the second RFIC 224 may convert a baseband signal generated by the first communication processor 212 or the second communication processor 214 to an RF signal (hereinafter, 5G Sub6 RF signal) of a Sub6 band (e.g., 6 GHz or less) to be used in the second cellular network 294 (e.g., 5G network). Upon reception, a 5G Sub6 RF signal may be obtained from the second cellular network 294 (e.g., 5G network) through an antenna (e.g., the second antenna module 244) and be pretreated through an RFFE (e.g., the second RFFE 234). The second RFIC 224 may convert the preprocessed 5G Sub6 RF signal to a baseband signal so as to be processed by a corresponding communication processor of the first communication processor 212 or the second communication processor 214.

The third RFIC 226 may convert a baseband signal generated by the second communication processor 214 to an RF signal (hereinafter, 5G Above6 RF signal) of a 5G Above6 band (e.g., about 6 GHz to about 60 GHz) to be used in the second cellular network 294 (e.g., 5G network). Upon reception, a 5G Above6 RF signal may be obtained from the second cellular network 294 (e.g., 5G network) through an antenna (e.g., the antenna 248) and be preprocessed through the third RFFE 236. The third RFIC 226 may convert the preprocessed 5G Above6 RF signal to a baseband signal so as to be processed by the second communication processor 214. According to an embodiment, the third RFFE 236 may be formed as part of the third RFIC 226.

According to an embodiment, the electronic device 101 may include a fourth RFIC 228 separately from the third RFIC 226 or as at least part of the third RFIC 226. In this case, the fourth RFIC 228 may convert a baseband signal generated by the second communication processor 214 to an RF signal (hereinafter, an intermediate frequency (IF) signal) of an intermediate frequency band (e.g., about 9 GHz to about 11 GHz) and transfer the IF signal to the third RFIC 226. The third RFIC 226 may convert the IF signal to a 5G Above 6RF signal. Upon reception, the 5G Above 6RF signal may be received from the second cellular network 294 (e.g., a 5G network) through an antenna (e.g., the antenna 248) and be converted to an IF signal by the third RFIC 226. The fourth RFIC 228 may convert an IF signal to a baseband signal so as to be processed by the second communication processor 214.

According to an embodiment, the first RFIC 222 and the second RFIC 224 may be implemented into at least part of a single package or a single chip. According to an embodiment, the first RFFE 232 and the second RFFE 234 may be implemented into at least part of a single package or a single chip. According to an embodiment, at least one of the first antenna module 242 or the second antenna module 244 may be omitted or may be combined with another antenna module to process RF signals of a corresponding plurality of bands.

According to an embodiment, the third RFIC 226 and the antenna 248 may be disposed at the same substrate to form a third antenna module 246. For example, the wireless communication module 192 or the processor 120 may be disposed at a first substrate (e.g., main PCB). In this case, the third RFIC 226 is disposed in a partial area (e.g., lower surface) of the first substrate and a separate second substrate (e.g., sub PCB), and the antenna 248 is disposed in another partial area (e.g., upper surface) thereof; thus, the third antenna module 246 may be formed. By disposing the third RFIC 226 and the antenna 248 in the same substrate, a length of a transmission line therebetween can be reduced. This may reduce, for example, a loss (e.g., attenuation) of a signal of a high frequency band (e.g., about 6 GHz to about 60 GHz) to be used in 5G network communication by a transmission line. Therefore, the electronic device 101 may improve a quality or speed of communication with the second cellular network 294 (e.g., 5G network).

According to an embodiment, the antenna 248 may be formed in an antenna array including a plurality of antenna elements that may be used for beamforming. In this case, the third RFIC 226 may include a plurality of phase shifters 238 corresponding to a plurality of antenna elements, for example, as part of the third RFFE 236. Upon transmission, each of the plurality of phase shifters 238 may convert a phase of a 5G Above6 RF signal to be transmitted to the outside (e.g., a base station of a 5G network) of the electronic device 101 through a corresponding antenna element. Upon reception, each of the plurality of phase shifters 238 may convert a phase of the 5G Above6 RF signal received from the outside to the same phase or substantially the same phase through a corresponding antenna element. This enables transmission or reception through beamforming between the electronic device 101 and the outside.

The second cellular network 294 (e.g., 5G network) may operate (e.g., stand-alone (SA)) independently of the first cellular network 292 (e.g., legacy network) or may be operated (e.g., non-stand alone (NSA)) in connection with the first cellular network 292. For example, the 5G network may have only an access network (e.g., 5G radio access network (RAN) or a next generation (NG) RAN and have no core network (e.g., next generation core (NGC)). In this case, after accessing to the access network of the 5G network, the electronic device 101 may access to an external network (e.g., Internet) under the control of a core network (e.g., an evolved packed core (EPC)) of the legacy network. Protocol information (e.g., LTE protocol information) for communication with a legacy network or protocol information (e.g., new radio (NR) protocol information) for communication with a 5G network may be stored in the memory 130 to be accessed by other components (e.g., the processor 120, the first communication processor 212, or the second communication processor 214).

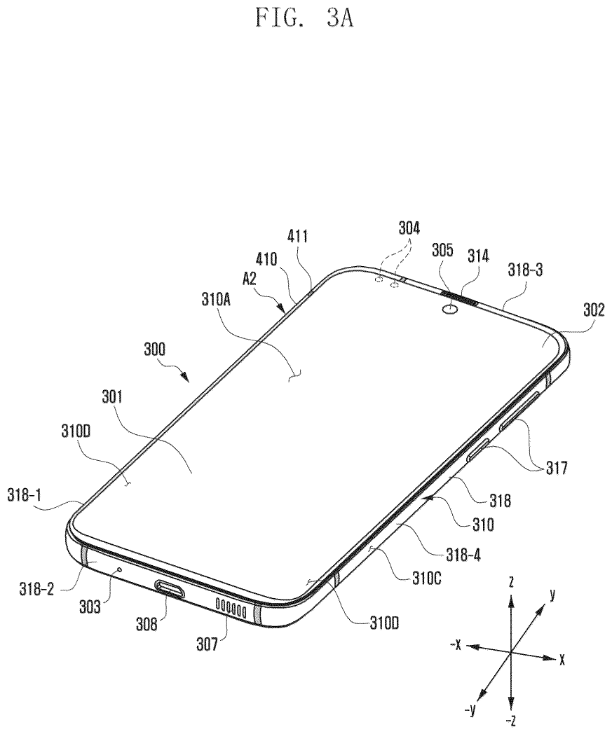

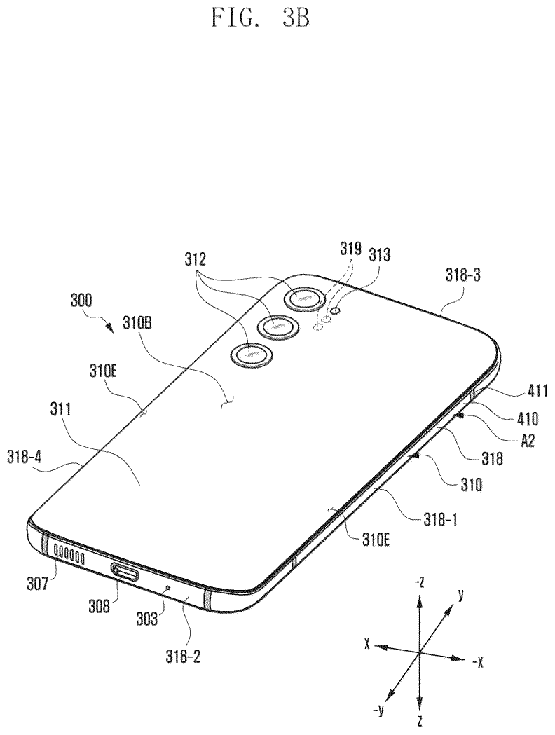

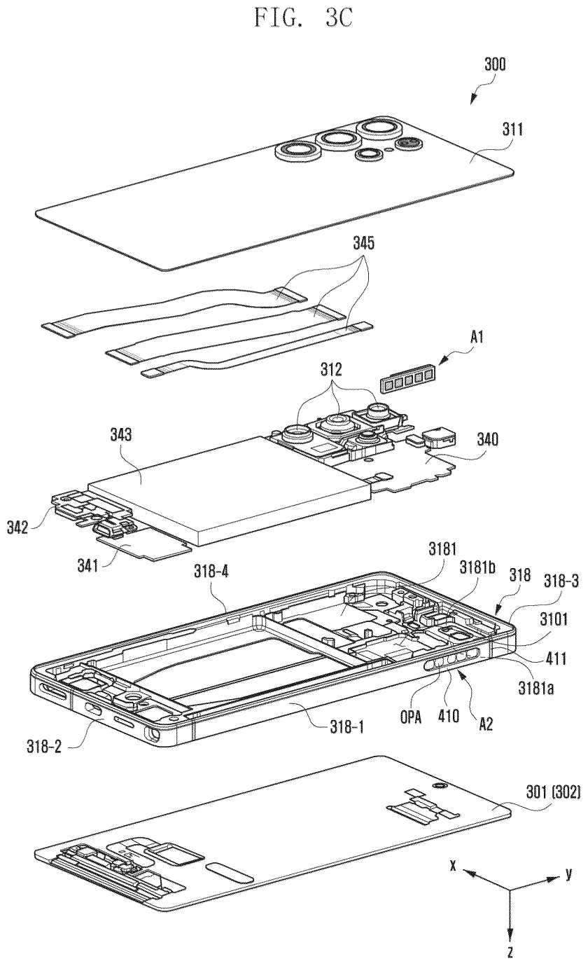

FIG. 3A is a perspective view of a front surface of an electronic device according to various embodiments of the present disclosure. FIG. 3B is a perspective view of a rear surface of the electronic device in FIG. 3A according to various embodiments of the present disclosure.

An electronic device 300 in FIGS. 3A and 3B may be at least partially similar to the electronic device 101 in FIG. 1, or may include other embodiments of the electronic device.

With reference to FIGS. 3A and 3B, the electronic device 300 according to an embodiment may include a housing 310 including a first surface (or front surface) 310A, a second surface (or rear surface) 310B, and a side surface 310C surrounding a space between the first surface 310A and the second surface 310B. In another embodiment, the housing 310 may refer to a structure that forms a portion of the first surface 310A, the second surface 310B, and the side surface 310C. According to an embodiment, the first surface 310A may be formed by a front surface plate 302 (e.g., a glass plate including various coating layers, or a polymer plate) that is at least partially substantially transparent. The second surface 310B may be formed by a rear surface plate 311 that is substantially opaque. The rear surface plate 311 may be formed, for example, of coated or tinted glass, ceramic, polymer, metal (e.g., aluminum, stainless steel (STS), or magnesium), or a combination of at least two of the above materials. The side surface 310C, which is coupled to the front surface plate 302 and the rear surface plate 311, may be formed by a lateral member (or “side surface bezel structure”) 318 including metal and/or polymer. In some embodiments, the rear surface plate 311 and the lateral member 318 may be integrally formed and may include the same material (e.g., metal material such as aluminum).

In the illustrated embodiment, the front surface plate 302 may include, at both ends of a long edge of the front surface plate, a first region 310D that is curved from the first surface 310A toward the rear surface plate and extended seamlessly. In the illustrated embodiment (with reference to FIG. 3B), the rear surface plate 311 may include, at both ends of a long edge thereof, a second region 310E that is curved from the second surface 310B toward the front surface plate and extended seamlessly. In some embodiments, the front surface plate 302 or the rear surface plate 311 may include only one of the first region 310D or the second region 310E. In some embodiments, the front surface plate 302 and the rear surface plate 311 may not include the first region and the second region, and may include only a flat plane disposed parallel to the second surface 310B. In the above embodiments, when viewed from the side surface of the electronic device, the lateral member 318 may have a first thickness (or width) at the side surface where the first region 310D or the second region 310E is not included, and may have a second thickness that is thinner than the first thickness at the side surface including the first region or the second region.

According to an embodiment, the electronic device 300 may include at least one of a display 301, an input device 303, an audio output device 307 or 314, a sensor module 304 or 319, a camera module 305, 312, or 313, a key input device 317, an indicator, or a connector 308. In some embodiments, the electronic device 300 may omit at least one of the above constituent elements (e.g., the key input device 317 or the indicator), or may further include other constituent elements.

The display 301, for example, may be exposed through a substantial portion of the front surface plate 302. In some embodiments, at least a portion of the display 301 may be exposed through the front surface plate 302, which forms the first surface 310A and the first region 310D of the side surface 310C. The display 301 may be coupled or disposed proximal to a touch detection circuit, a pressure sensor capable of measuring intensity (pressure) of a touch, and/or a digitizer capable of detecting a magnetic field type stylus pen. In some embodiments, at least a portion of the sensor module 304 or 319, and/or at least a portion of the key input device 317 may be disposed in the first region 310D and/or the second region 310E.

The input device 303 may include a microphone. In some embodiments, the input device 303 may include a plurality of microphones disposed to detect a direction of sound. The audio output device 307 or 314 may include speakers. The speakers may include an external speaker 307 and a receiver 314 for calls. In some embodiments, the microphone, the speakers, and the connector 308 may be disposed in the space of the electronic device 300, and may be exposed to an external environment through at least one hole formed in the housing 310. In some embodiments, a hole formed in the housing 310 may be commonly used for the microphones and the speakers. In some embodiments, the audio output device 307 or 314 may include a speaker (e.g., a piezoelectric speaker) that operates without a hole formed in the housing 310. In some embodiments, the electronic device 300 may include a tray member disposed through at least a portion of the lateral member 318.

The sensor module 304 or 319 may generate electrical signals or data values corresponding to an internal operation state of the electronic device 300, or an external environmental state. The sensor module 304 or 319, for example, may include a first sensor module 304 (e.g., proximity sensor) disposed on the first surface 310A of the housing 310, and/or a second sensor module (e.g., fingerprint sensor), and/or a third sensor module 319 (e.g., heart rate monitor (HRM) sensor) disposed on the second surface 310B of the housing 310. The fingerprint sensor may be disposed on the first surface 310A of the housing 310. The fingerprint sensor (e.g., an ultrasonic type or optical type fingerprint sensor) may be disposed under the display 301 of the first surface 310A. The electronic device 300 may further include at least one of a sensor module, such as a gesture sensor, a gyroscope sensor, a barometric pressure sensor, a magnetic sensor, an acceleration sensor, a grip sensor, a color sensor, an infrared (IR) sensor, a biometric sensor, a temperature sensor, a humidity sensor, or a brightness sensor 304.

The camera module 305, 312, or 313 may include a first camera module (device) 305 disposed on the first surface 310A of the electronic device 300, a second camera module (device) 312 disposed on the second surface 310B, and/or a flash 313. The camera modules 305 and 312 may include one or more lenses, an image sensor, and/or an image signal processor. The flash 313 may include, for example, a light-emitting diode or a xenon lamp. In some embodiments, two or more lenses (e.g., wide-angle and telephoto lenses) and image sensors may be disposed on one surface of the electronic device 300.

The key input device 317 may be disposed on the side surface 310C of the housing 310. In another embodiment, the electronic device 300 may not include some or all of the above-mentioned key input devices 317, and the key input device 317 not included may be implemented in another form such as a soft key on the display 301. In another embodiment, the key input device 317 may be implemented by using a pressure sensor included in the display 301.

The indicator, for example, may be disposed on the first surface 310A of the housing 310. The indicator may provide, for example, state information of the electronic device 300 in the form of light. In another embodiment, a light-emitting element, for example, may provide a light source that operates together with the operation of the camera module 305. The indicator may include, for example, an LED, an IR LED, and a xenon lamp.

The connector 308 may include a first connector hole 308 that may accommodate a connector (e.g., a USB connector or an IF module (interface connector port module)) for transmitting and receiving power and/or data to/from an external electronic device, and/or a second connector hole (or earphone jack) that may accommodate a connector for transmitting and receiving audio signals to/from the external electronic device.

A particular camera module 305 among the camera modules 305 and 312, a particular sensor module 304 among the sensor modules 304 and 319, or the indicator may be disposed to be exposed through the display 301. For example, the camera module 305, the sensor module 304, or the indicator may be disposed in an internal space of the electronic device 300 to be in contact with the external environment through an opening or transmissive region perforated up to the front surface plate 302 of the display 301. In an embodiment, a region where the display 301 and the camera module 305 face each other may be formed as a transmissive region having a certain transmittance as a portion of a region for displaying content. In an embodiment, the transmissive region may be formed to have a transmittance in a range of approximately 5% to approximately 20%. Such a transmissive region may include a region overlapping with an effective area (e.g., angle of view region) of the camera module 305 through which light, for forming an image on an image sensor, passes. For example, the transmissive region of the display 301 may include a region having a lower pixel density than its surroundings. For example, the transmissive region may replace the opening. For example, the camera module 305 may include an under display camera (UDC). In another embodiment, some a particular sensor module 304 may be disposed so as to perform its function without being visually exposed through the front surface plate 302 in an internal space of the electronic device. For example, in such a case, a region of the display 301 facing the sensor module may not require a perforated opening.

According to various embodiments, the lateral member 318 may include a first side surface 318-1 having a first length along a first direction (e.g., ±y-axis direction), a second side surface 318-2 extending from one end of the first side surface 318-1, having a second length shorter than the first length along a second direction perpendicular to the first direction (e.g., ±x-axis direction), a third side surface 318-3 extending from the other end of the first side surface 318-1, in parallel with the second side surface 318-2, and having the second length, and a fourth side surface 318-4 connecting the second side surface 318-2 and the third side surface 318-3, and having the first length, parallel to the first side surface 318-1. In an embodiment, the lateral member 318 may be formed at least partially of a conductive member. In an embodiment, the lateral member 318 may include a conductive portion 410 that is electromagnetically segmented through a non-conductive portion 411 disposed on a portion of the first side surface 318-1.

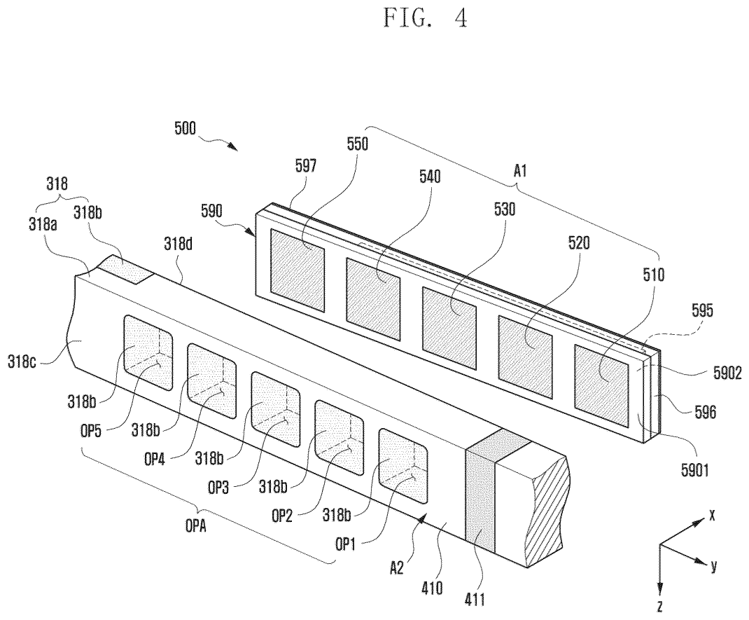

According to various embodiments, the electronic device 300 may include an antenna module (e.g., the antenna module 500 in FIG. 4) that is disposed in an internal space and disposed through at least a portion of the first side surface 318-1 to form a directional beam (e.g., beam pattern or wireless signal) to the outside of the electronic device 300. In an embodiment, the antenna module 500 may operate as a first antenna (e.g., the first antenna A1 in FIG. 4) (mmWave antenna) configured to transmit and/or receive a wireless signal in a frequency band of approximately 3 GHz to 300 GHz. In an embodiment, the electronic device 300 may operate as a second antenna A2 (legacy antenna) configured to transmit and/or receive a wireless signal in a frequency band of approximately 600 MHz to 6000 MHz through the conductive portion 410.

According to various embodiments, the first antenna A1 may be disposed to radiate a directional beam to the outside of the electronic device 300 through at least one opening formed in the conductive portion 410 (e.g., the opening array OPA in FIG. 4). In an embodiment, with respect to a specific spacing distance (e.g., a minimum spacing distance not affecting radiation performance of the second antenna A2), the tilting of the first antenna A1, in the internal space of the electronic device 300, creates a closer distance than such specific spacing distance, which induces radiation performance improvement of the first antenna A1 and helps maintain radiation performance of the second antenna A2.

FIG. 3C is an expanded perspective view of the electronic device in FIG. 3B according to various embodiments of the present disclosure.

With reference to FIG. 3C, the electronic device 300 may include a lateral member 318 (e.g., side surface bezel structure or side surface frame), an extension member 3181 (e.g., bracket, support member, or support structure) extending from the lateral member 318 into an internal space 3101 of the electronic device 300, a front surface cover 302 (e.g., front surface plate, first plate, or first cover) coupled to one side of the lateral member 318, and a rear surface cover 311 (e.g., rear surface plate, second plate, or second cover) coupled to the other side of the lateral member 318 facing opposite to the front surface cover 302. In an embodiment, the electronic device 300 may include a housing (e.g., the housing 310 in FIG. 3A) (e.g., a housing structure) formed by combining the lateral member 318, the front surface cover 302, and the rear surface cover 311. In an embodiment, the electronic device 300 may include a display 301, a substrate 340 including the camera module 312, a battery 343, a sub-substrate 341 disposed apart from the substrate 340 with the battery 343 interposed therebetween, and a module assembly 342 (e.g., speaker assembly, microphone assembly, or interface connector assembly) electrically connected to the sub-substrate 341, all disposed in an internal space 3101 of the housing. In some embodiments, the electronic device 300 may omit at least one of the constituent elements or additionally include other constituent elements. At least one of the constituent elements of the electronic device 300 may be the same as or similar to at least one of the constituent elements of the electronic device 101 in FIGS. 1 and 2, or the electronic device 300 in FIG. 3A, and redundant descriptions are omitted below.

According to various embodiments, the extension member 3181 may be disposed inside the electronic device 300, and may be connected to the lateral member 318 or integrally formed with the lateral member 318. The extension member 3181 may be formed, for example, of a metal material and/or a non-metal material (e.g., polymer). The extension member 3181 may have the display 301 coupled to a first surface 3181a, and the substrate 340, the sub-substrate 341, the module assembly 342, and the battery 343 may be coupled to a second surface 3181b facing an opposite direction to the first surface 3181a. The electronic device 300 may include a processor, a memory, and/or an interface disposed on the substrate 340. The processor may include, for example, one or more of a central processing unit (CPU), an application processor, a graphics processing unit (GPU), an image signal processor, a sensor hub processor, or a communication processor.

The memory may include, for example, volatile memory or non-volatile memory.

The interface may include, for example, a high definition multimedia interface (HDMI), a universal serial bus (USB) interface, an SD card interface, and/or an audio interface. The interface may, for example, electrically or physically connect the electronic device 300 to an external electronic device, and may include a USB connector, an SD card/MMC connector, or an audio connector.

The battery 343 is a device for supplying power to at least one constituent element of the electronic device 300, and may include, for example, a non-rechargeable primary battery, a rechargeable secondary battery, or a fuel cell. At least a portion of the battery 343 may, for example, be disposed side-by-side to be located on substantially the same plane as the substrate 340 and the sub-substrate 341. The battery 343 may be embedded in the electronic device 300. In some embodiments, the battery 343 may be disposed to be detachable from the electronic device 300.

According to various embodiments, the electronic device 300 may include at least one electrical connection device 345 for electrically connecting the substrate 340 and the sub-substrate 341. In an embodiment, the at least one electrical connection device 345 may be disposed to electrically connect the substrate 340 to the sub-substrate 341, or to electrically connect the substrate 340 to the module assembly 342.

According to various embodiments, the electronic device 300 may include an antenna module (e.g., the antenna module 500 in FIG. 4) disposed in an internal space 3101 and disposed, through at least a portion of the first side surface 318-1, to form a directional beam to the outside of the electronic device 300. In an embodiment, the antenna module 500 may operate as a first antenna A1 (mmWave antenna) configured to transmit and/or receive a wireless signal in a frequency band of approximately 3 GHz to 300 GHz. In an embodiment, the electronic device 300 may operate as a second antenna A2 (legacy antenna) configured to transmit and/or receive a wireless signal in a frequency band of approximately 600 MHz to 6000 MHz through the conductive portion 410.

According to various embodiments, the first antenna A1 may be disposed on the first side surface 318-1 so as to form a directional beam to the outside of the electronic device 300 through at least one opening OPA formed in the conductive portion 410. In an embodiment, with respect to a specific spacing distance (e.g., a minimum spacing distance not affecting radiation performance of the second antenna A2), the tilting of the first antenna A1, in the internal space of the electronic device 300, creates a closer distance at one end thereof than such specific spacing distance, which induces radiation performance improvement of the first antenna A1 and helps maintain radiation performance of the second antenna A2.

FIG. 4 is a perspective view illustrating a disposition structure of an antenna module and a conductive portion according to various embodiments of the present disclosure.

With reference to FIG. 4, the electronic device (e.g., the electronic device 300 in FIG. 3C) may include an antenna module 500 (e.g., antenna structure or antenna device) disposed in an internal space (e.g., the internal space 3101 in FIG. 3C) and disposed, through at least a portion of the first side surface (e.g., the first side surface 318-1 in FIG. 3C), to form a directional beam to the outside of the electronic device 300. In an embodiment, the antenna module 500 may operate as the first antenna A1 for the electronic device 300. In an embodiment, the electronic device (e.g., the electronic device 300 in FIG. 3C) may include the conductive portion 410 that is electromagnetically segmented through the non-conductive portion 411 disposed on at least a portion of the lateral member 318. In an embodiment, the conductive portion 410 may operate as the second antenna A2 for the electronic device.

According to various embodiments, the antenna module 500 may include a substrate 590 (e.g., a printed circuit board) disposed in the internal space of the electronic device (e.g., the internal space 3101 in FIG. 3C) and a plurality of antenna elements 510, 520, 530, 540, and 550 disposed on the substrate and spaced apart from each other. In an embodiment, the substrate 590 may include a first substrate surface 5901 and a second substrate surface 5902 facing a direction opposite to the first substrate surface 5901. In an embodiment, the plurality of antenna elements 510, 520, 530, 540, and 550 may be disposed, in a space between the first substrate surface 5901 and the second substrate surface 5902, in a position relatively closer to the first substrate surface 5901 than the second substrate surface 5902, or may be exposed on the first substrate surface 5901. In an embodiment, each of the plurality of antenna elements 510, 520, 530, 540, and 550 may operate as the first antenna A1 (e.g., array antenna) by being electrically connected, through at least one feeding portion, to a wireless communication circuit (e.g., the wireless communication module 192 in FIG. 1) disposed on the second substrate surface 5902. In an embodiment, the plurality of antenna elements 510, 520, 530, 540, and 550 may include conductive patches and/or conductive patterns disposed on the substrate 590. In some embodiments, the plurality of antenna elements 510, 520, 530, 540, and 550 may be disposed on the first substrate surface 5901 of the substrate 590, and may be replaced with chip antennas including a ceramic substrate and conductive patches disposed on the ceramic substrate.

According to various embodiments, the antenna module 500 may include a wireless communication circuit 595 (e.g., first wireless communication circuit) disposed on the second substrate surface 5902 of the substrate 590 and electrically connected to the plurality of antenna elements 510, 520, 530, 540, and 550. In some embodiments, the wireless communication circuit 595 may be disposed, in the internal space (e.g., the internal space 3101 in FIG. 3C) of the electronic device (e.g., the electronic device 300 in FIG. 3C), at a position spaced apart from the substrate 590 on a printed circuit board (PCB) (e.g., the substrate 340 in FIG. 3C) (e.g., main board or device board), and may be electrically connected to the substrate 590 through an electrical connection member (e.g., FRC, flexible RF cable).

According to various embodiments, the antenna module 500 may include a protection member 596 that is disposed on the second substrate surface 5902 of the substrate 590 and disposed to at least partially surround the wireless communication circuit 595. In an embodiment, the protection member 596 may include a dielectric that is disposed as a protective layer surrounding the wireless communication circuit 595, and is cured and/or solidified after application. In an embodiment, the protection member 596 may include an epoxy resin. In an embodiment, the protection member 596 may be disposed to surround all or a portion of the wireless communication circuit 595 on the second substrate surface 5902 of the substrate 590. In an embodiment, the antenna module 500 may include a conductive shielding layer 597 that is stacked on a surface of the protection member 596. According to an embodiment, the conductive shielding layer 597 may shield noise (e.g., DC-DC noise or interference frequency constituent elements) generated by the antenna module 500 from being transmitted to the surroundings. In an embodiment, the conductive shielding layer 597 may include a conductive material (e.g., conductive coating) applied to the surface of the protection member 596 by a thin-film deposition method such as sputtering. In an embodiment, the conductive shielding layer 597 may be electrically connected to the ground of the substrate 590. In another embodiment, the protection member 596 and/or the conductive shielding layer 597 may be replaced with a shield can mounted on the substrate 590.

According to various embodiments, the lateral member 318 may include a conductive member 318a and a non-conductive member 318b coupled to the conductive member 318a. In an embodiment, the non-conductive member 318b may be coupled to the conductive member 318a through injection molding. In some embodiments, the non-conductive member 318b may be structurally coupled to the conductive member 318a. In an embodiment, the non-conductive member 318b may form at least a portion of an extension member (e.g., the extension member 3181 in FIG. 3C) (e.g., bracket) extending from the lateral member 318 into an internal space (e.g., the internal space 3101 in FIG. 3C) of the electronic device (e.g., the electronic device 300 in FIG. 3C).

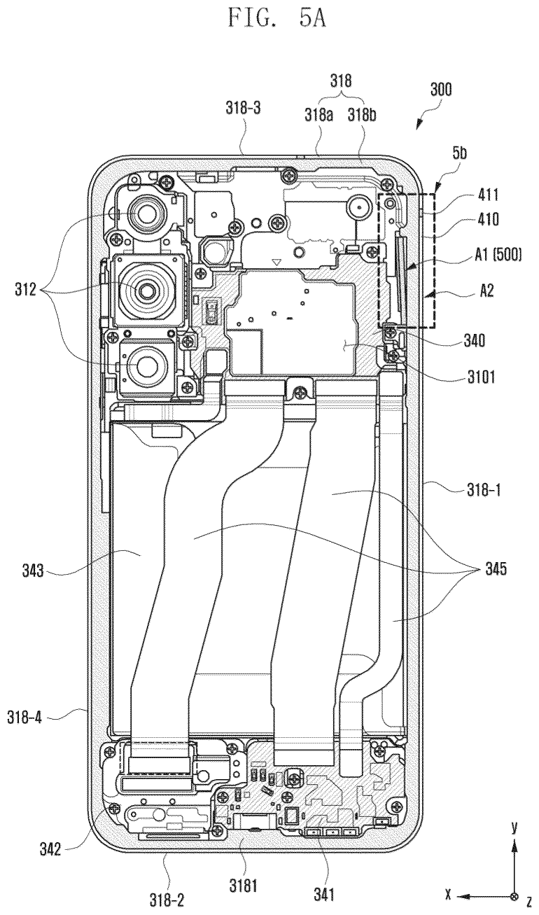

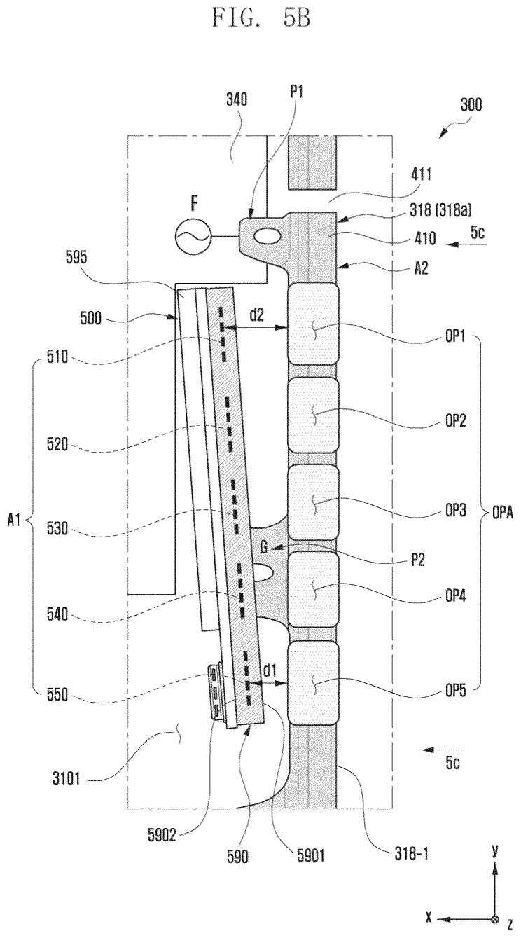

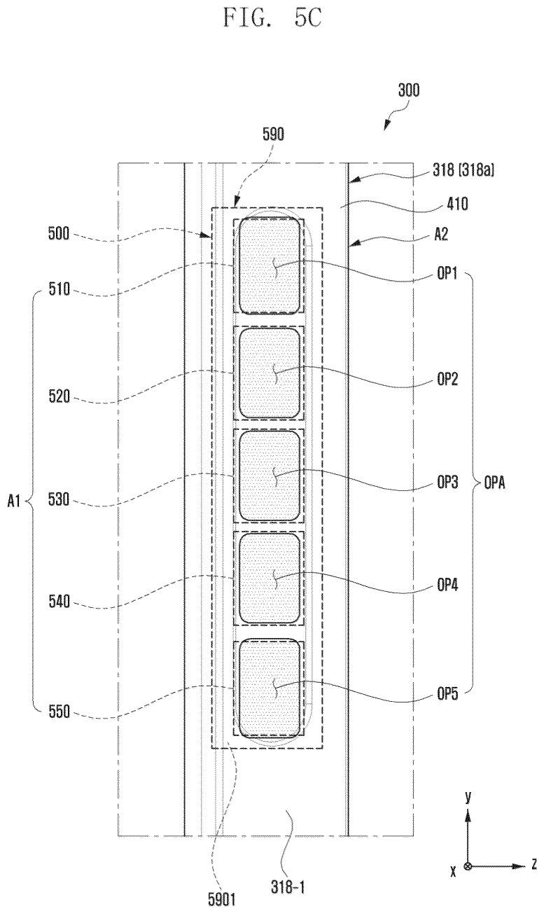

According to various embodiments, the lateral member 318 may include a conductive portion 410 electromagnetically segmented through the non-conductive portion 411 (e.g., segmentation portion, slit, or gap) disposed on at least a portion of the conductive member 318a. In an embodiment, the non-conductive portion 411 may be disposed through an extension of the non-conductive member 318b. In some embodiments, the non-conductive portion 411 may be a dielectric different in material from the non-conductive member 318b. In an embodiment, the conductive portion 318a may operate as the second antenna A2 by being electrically connected to a wireless communication circuit (e.g., the wireless communication module 192 in FIG. 1) (e.g., second wireless communication circuit) at at least one point (e.g., feeding point P1 in FIG. 5B). In an embodiment, the lateral member 318 may include a plurality of openings OP1, OP2, OP3, OP4, and OP5 (e.g., through-holes) (e.g., opening array OPA) disposed at positions corresponding to the plurality of antenna elements 510, 520, 530, 540, and 550 of the antenna module 500 in the conductive portion 410. In an embodiment, the plurality of openings OP1, OP2, OP3, OP4, and OP5 may be formed in a manner that penetrates from an outer surface 318c to an inner surface 318d of the lateral member 318. In an embodiment, the plurality of openings OP1, OP2, OP3, OP4, and OP5 may be filled with the non-conductive member 318b. In an embodiment, the substrate 590 of the antenna module 500 may be disposed in the internal space 3101 of the electronic device 300 such that, substantially, in a manner that the first antenna element 510 corresponds to the first opening OP1, the second antenna element 520 corresponds to the second opening OP2, the third antenna element 530 corresponds to the third opening OP3, the fourth antenna element 540 corresponds to the fourth opening OP4, and the fifth antenna element 550 corresponds to the fifth opening OP5, the first substrate surface 5901 faces the inner surface 318d of the conductive portion 410. In an embodiment, when the lateral member 318 is viewed from outside (e.g., when the outer surface 318c of the lateral member 318 is viewed from a perpendicular direction), each of the plurality of openings OP1, OP2, OP3, OP4, and OP5 may be disposed so as to correspondingly overlap, at least partially, with each of the plurality of antenna elements 510, 520, 530, 540, and 550. Accordingly, a directional beam formed from the antenna module 500 may be radiated to the outside of the electronic device 300 through each of the plurality of openings OP1, OP2, OP3, OP4, and OP5.

In some embodiments, the substrate 590 of the antenna module 500 may be disposed to be tilted through a recess (e.g., substrate mounting portion) formed in the extension member 3181 so as to support at least a portion of the substrate 590. In an embodiment, the recess may be formed lower than a surface of the extension member 3181. In some embodiments, the recess may be formed or disposed on the extension member 3181, and may be replaced with an additional support structure for tilted disposition of the substrate 590.

According to exemplary embodiments of the present disclosure, the substrate 590 of the antenna module 500 may be disposed to be inclined or tilted with respect to the conductive portion 410 such that the first substrate surface 5901 is inclined or tilted in a lengthwise direction with respect to the inner surface 318d of the conductive portion 410, i.e., the first substrate surface 5901 is not parallel to the inner surface 318d of the conductive portion 410 (e.g., lateral member 318) In other words, the substrate 590 is disposed so that an acute angle is formed between a plane of the first substrate surface 5901 and a plane of the inner surface 318d of the conductive portion 410. In an embodiment, the substrate 590 of the antenna module 500 operating as the first antenna A1 may be disposed to be spaced apart such that a specific point does not affect the radiation performance of the conductive portion 410 operating as the second antenna A2. In an embodiment, the substrate 590 of the antenna module 500 may be tilted or inclined with respect to the conductive portion 410 so as to become closer to the conductive portion 410 as the substrate 590 extends farther from a specific point. For example, the specific point may include a point overlapping a feeding point (e.g., feeding point P1 in FIG. 5B) of the conductive portion 410 when the lateral member 318 is viewed from outside. This tilted disposition of the substrate 590 may induce radiation performance improvement of the first antenna A1 and help maintain radiation performance of the second antenna A2.

FIG. 5A is a configuration diagram illustrating a rear surface of an electronic device according to various embodiments of the present disclosure. FIG. 5B is an enlarged view of a region 5b in FIG. 5A according to various embodiments of the present disclosure. FIG. 5C is a diagram of the electronic device viewed along a direction 5c-5c of FIG. 5B according to various embodiments of the present disclosure.

FIG. 5A is a plan view illustrated from a rear surface direction of the electronic device 300, in a state where the rear surface cover (e.g., the rear surface cover 311 in FIG. 3C) is removed.

With reference to FIGS. 5A, 5B, and 5C, the electronic device 300 may include a front surface cover (e.g., the front surface cover 302 in FIG. 3C) facing a first direction (e.g., z-axis direction), a rear surface cover (e.g., the rear surface cover 311 in FIG. 3C) facing a second direction (e.g., −z-axis direction) opposite to the first direction, and a lateral member 318 that surrounds a space 3101 (e.g., the internal space of the electronic device 300) between the front surface cover 302 and the rear surface cover 311. In an embodiment, the electronic device 300 may include the extension member 3181 extending from the lateral member 318 into the space 3101. In an embodiment, the electronic device 300 may include a display (e.g., the display 301 in FIG. 3C) that is disposed in the space 3101 so as to be at least partially supported by the extension member 3181, and may be visible from the outside through at least a portion of the front surface cover 302. In an embodiment, the lateral member 318 may include a conductive member 318a (e.g., metal) and a non-conductive member 318b (e.g., polymer) coupled to the conductive member 318a. In an embodiment, the lateral member 318 may include a first side surface 318-1 having a first length along a first direction (e.g., ±y-axis direction), a second side surface 318-2 extending from one end of the first side surface 318-1, having a second length shorter than the first length along a second direction perpendicular to the first direction (e.g., ±x-axis direction), a third side surface 318-3 extending from the other end of the first side surface 318-1, in parallel with the second side surface 318-2, and having the second length, and a fourth side surface 318-4 connecting the second side surface 318-2 and the third side surface 318-3, and having the first length, parallel to the first side surface 318-1. In an embodiment, the lateral member 318 may include a conductive portion 410 that is electromagnetically segmented through a non-conductive portion 411 disposed on a portion of the first side surface 318-1.

According to various embodiments, the electronic device 300 may include the antenna module 500 that is disposed in the space 3101 and disposed to form a directional beam to the outside of the electronic device 300 through at least a portion of the first side surface 318-1. In an embodiment, the antenna module 500 may operate as the first antenna A1 that is configured to transmit and/or receive a wireless signal in at least one first frequency band (e.g., approximately 3 GHz to 300 GHz) through a first wireless communication circuit 595 disposed on the second substrate surface 5902 of the substrate 590.

According to various embodiments, the conductive portion 410 may be electrically connected at a feeding point P1 with a second wireless communication circuit (e.g., the wireless communication module 192 in FIG. 1) disposed on the substrate 340. Accordingly, the conductive portion 410 may operate as the second antenna A2 that is configured to transmit and/or receive a wireless signal in at least one second frequency band (e.g., approximately 600 MHz to 6000 MHz) that is different from the at least one first frequency band.

According to various embodiments, the lateral member 318 may include the plurality of openings OP1, OP2, OP3, OP4, and OP5 (e.g., an opening array OPA) that are disposed at positions corresponding to the plurality of antenna elements 510, 520, 530, 540, and 550 of the antenna module 500 in the conductive portion 410. In an embodiment, the substrate 590 may be disposed such that the first substrate surface 5901 faces the conductive portion 410. In an embodiment, the substrate 590 may be disposed on at least a portion of the extension member 3181 and/or the lateral member 318 such that the first substrate surface 5901 is perpendicular to the front surface cover 302 and/or the rear surface cover 311. In an embodiment, the substrate 590 may be disposed such that the first substrate surface 5901 is perpendicular to the surface of the display 301.

According to various embodiments, the substrate 590 of the antenna module 500 may be disposed in a manner that the first substrate surface 5901 is tilted or inclined in the lengthwise direction (e.g., +y-axis direction) with respect to conductive portion 410 so as to be not parallel in the lengthwise direction (e.g., +y-axis direction) to the conductive portion 410. In an embodiment, when the front surface cover 302 and/or the rear surface cover 311 is viewed from above, the substrate 590 and the conductive portion 410 may be disposed to be not parallel in the lengthwise direction (e.g., +y-axis direction). In an embodiment, when the surface of the display 301 is viewed from above, the substrate 590 and the conductive portion 410 may be disposed to be not parallel in the lengthwise direction (e.g., ty-axis direction). In an embodiment, with respect to points along the conductive portion 410 having the shortest distance to the substrate 590, it may be tilted such that the farther away such points are from the feeding point P1, the closer the substrate 590 is thereto. In an embodiment, the feeding point P1 may include a feeding point that is electrically connected to a wireless communication circuit F (e.g., the wireless communication module 192 in FIG. 1) disposed on the printed circuit board 340 of the electronic device 300. In an embodiment, the conductive portion 410 may include a ground point P2 spaced apart from the feeding point P1, which is electrically connected to a ground G of the printed circuit board 340. In an embodiment, the operating frequency band of the second antenna A2 may be determined according to the position of the ground point P2. In an embodiment, the substrate 590 may be disposed to have a maximum spacing distance from the feeding point P1, and may be tilted to be closer to the conductive portion 410 in the direction from the feeding point P1 toward the ground point P2. For example, with respect to points along the conductive portion 410 having the shortest distance to the substrate 590, it may be disposed such that the farther away such points are from the feeding point P1, the closer the substrate 590 is thereto.

In some embodiments, the substrate 590 may be tilted such that a first distance between the feeding point P1 of the conductive portion 410 and the substrate 590 is greater than a second distance between the ground point P2 of the conductive portion 410 and the substrate 590. In this case, the first distance may be set to be greater than approximately 2 mm.

According to various embodiments, the substrate 590 may be tilted such that a maximum proximity distance d1 between the antenna element 550, which is disposed closest to the conductive portion 410 among the plurality of antenna elements 510, 520, 530, 540, and 550 and the conductive portion 410 is located in the range of approximately 0.05 mm to 0.3 mm. In some embodiments, the substrate 590 may be tilted such that a maximum proximity distance between a ground (e.g., ground layer) of the substrate 590 and the conductive portion 410 is located in the range of 0.05 mm to 0.3 mm. In an embodiment, the substrate 590 may be configured such that a spacing distance d2 between the antenna element 510, which is disposed farthest from the conductive portion 410 among the plurality of antenna elements 510, 520, 530, 540, and 550, and the conductive portion 410 is set to be approximately 2.5 mm or more. The spacing distance d2 may include a minimum spacing distance that does not affect the radiation performance of the second antenna A2, based on the disposition of the first antenna A1. In some embodiments, the substrate 590 may be determined such that a spacing distance between a ground (e.g., ground layer) of the substrate 590 and the conductive portion 410 is located in the range of approximately 2.5 mm to 2.6 mm.

<Table 1> below shows, in the N261 band (e.g., approximately 28 GHz), a cumulative distribution function (CDF) for each section of the first antenna A1 in case of an exemplary embodiment of the present disclosure, in which the substrate 590 is tilted with respect to the conductive portion 410 (e.g., a tilted case in which a maximum spacing distance between the substrate 590 and the conductive portion 410 is approximately 2.5 mm, and a minimum spacing distance between the substrate 590 and the conductive portion 410 is approximately 0.3 mm), and in case of a comparative example, in which the substrate 590 is disposed in parallel with the conductive portion 410.

With reference to <Table 1> below, it can be seen that the first antenna A1, in the N261 band, exhibits relatively superior radiation performance in case where the substrate 590 is tilted to become gradually closer to the conductive portion 410, compared to the case where the substrate 590 is disposed in parallel with the conductive portion 410.

TABLE 1

| | N261 Simulation Results | | | | | | | | |
|---|---|---|---|---|---|---|---|---|---|
| | low(dB) | | | mid(dB) | | | high(dB) | | |
| CDF | 20% | 50% | Peak | 20% | 50% | Peak | 20% | 50% | Peak |
| Parallel disposition | −1.6 | 2.99 | 8.1 | −1.38 | 2.97 | 8.65 | −1.35 | 3.1 | 9.04 |
| Tilted disposition | −1.12 | 3.1 | 8.43 | −1.03 | 3.34 | 8.84 | −1.06 | 3.48 | 9.24 |

<Table 2> below shows, in the N260 band (e.g., approximately 39 GHz), a cumulative distribution function (CDF) for each section of the first antenna A1 in case of an exemplary embodiment of the present disclosure, in which the substrate 590 is tilted with respect to the conductive portion 410 (e.g., a tilted case in which a maximum spacing distance between the substrate 590 and the conductive portion 410 is approximately 2.5 mm, and a minimum spacing distance between the substrate 590 and the conductive portion 410 is approximately 0.3 mm), and in case of a comparative example, in which the substrate 590 is disposed in parallel with the conductive portion 410.

With reference to <Table 2> below, it can be seen that the first antenna A1, in the N260 band, exhibits relatively superior radiation performance in case where the substrate 590 is tilted to become gradually closer to the conductive portion 410, compared to the case where the substrate 590 is disposed in parallel with the conductive portion 410.

TABLE 2

| | N260 Simulation Results | | | | | | | | |
|---|---|---|---|---|---|---|---|---|---|
| | low(dB) | | | mid(dB) | | | high(dB) | | |
| CDF | 20% | 50% | Peak | 20% | 50% | Peak | 20% | 50% | Peak |
| Parallel disposition | −2.9 | 1.82 | 10.68 | −3.35 | 2.23 | 10.08 | −3.68 | 2.37 | 9.02 |
| Tilted disposition | −2.39 | 2.84 | 10.95 | −2.61 | 3.13 | 10.9 | −3.14 | 2.61 | 10.37 |

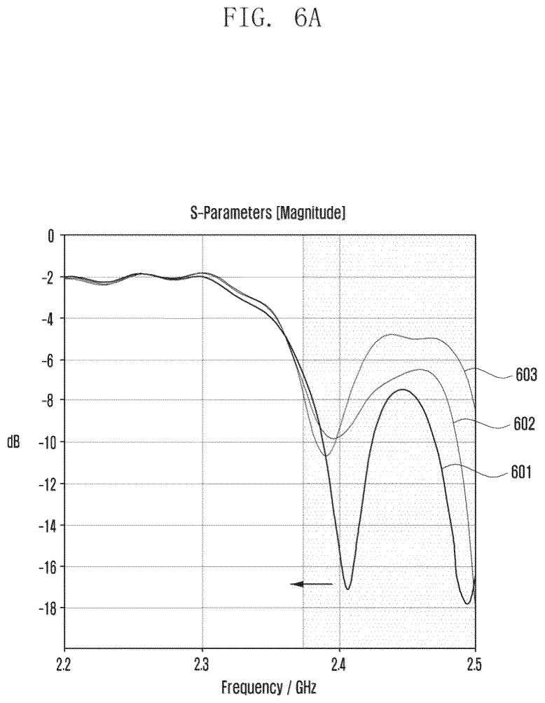

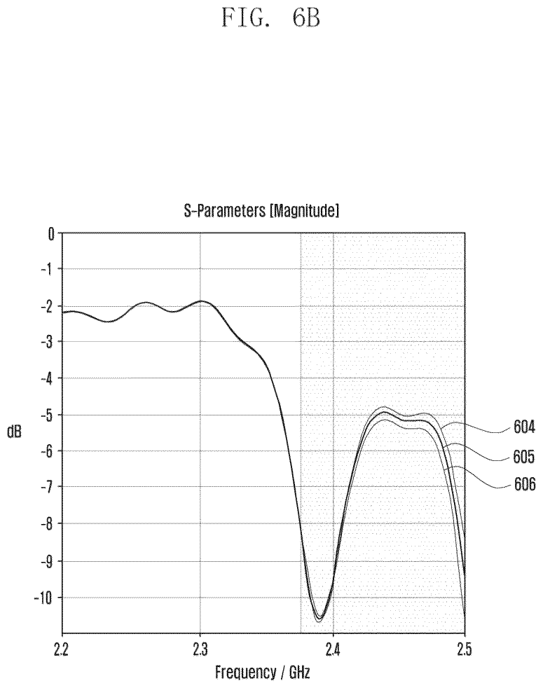

FIGS. 6A and 6B are graphs comparing the radiation performance of a second antenna depending on whether an antenna module of a first antenna is tilted when the antenna module is in close proximity to a conductive portion, according to various embodiments of the present disclosure.

With reference to FIG. 6A, in a comparative example where the substrate 590 is disposed in parallel with the conductive portion 410, the substrate 590 is spaced apart from the conductive portion 410 by a specific spacing distance such that the first antenna A1 does not affect the radiation performance of the second antenna A2 operating in a specific frequency band (e.g., approximately 2.4 GHz) (e.g., graph 601). For the case where the substrate 590 is moved by 0.3 mm toward the conductive portion 410 (e.g., graph 602) and the case where it is moved relatively closer by 0.5 mm (e.g., graph 603), it can be seen that the operating frequency band of the first antenna A1 is gradually shifted downward unintentionally, thereby resulting in degraded radiation performance.

With reference to FIG. 6B, in an exemplary embodiment of the present disclosure where the substrate 590 is tiltedly disposed with respect to the conductive portion 410, the substrate 590 is spaced apart from the conductive portion 410 by a specific spacing distance such that the first antenna A1 does not affect the radiation performance of the second antenna A2 operating in a specific frequency band (e.g., approximately 2.4 GHz) (e.g., graph 604). For the case where a certain point of the substrate 590 is tilted to be closer by 0.3 mm toward the conductive portion 410 (e.g., graph 605) and the case where it is tilted relatively closer by 0.5 mm (e.g., graph 606), it can be seen that the operating frequency band of the first antenna A1 operates in the same frequency band.

This may indicate that when the substrate 590 is tilted to gradually become closer to the conductive portion 410, it may help exhibit superior radiation performance of the first antenna A1 without reducing the radiation performance of the second antenna A2.

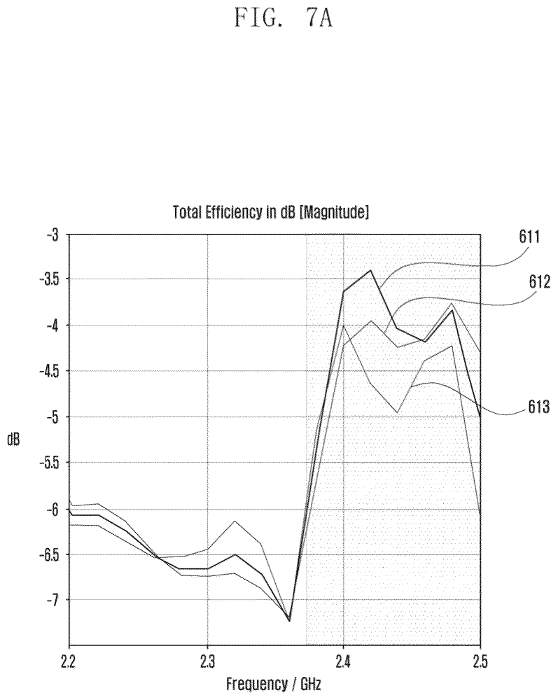

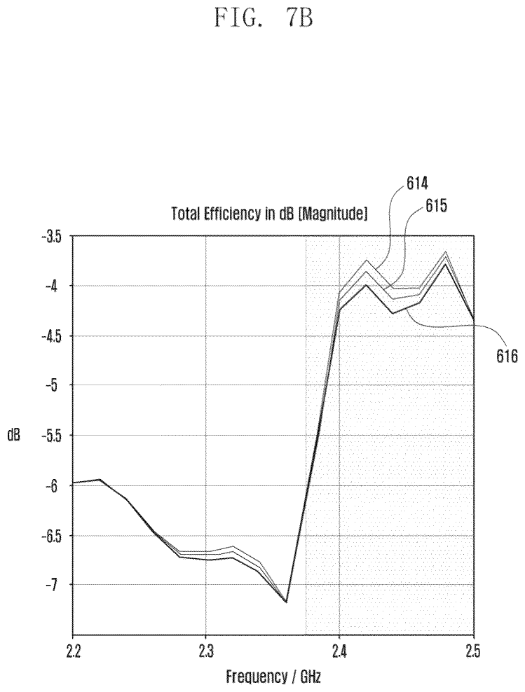

FIGS. 7A and 7B are graphs comparing radiation performance of a second antenna depending on whether an antenna module of a first antenna is tilted when the antenna module is in close proximity to a conductive portion, according to various embodiments of the present disclosure.

With reference to FIG. 7A, in a comparative example where the substrate 590 is disposed in parallel with the conductive portion 410, the substrate 590 is spaced apart from the conductive portion 410 by a specific spacing distance such that the first antenna A1 does not affect the radiation performance of the second antenna A2 operating in a specific frequency band (e.g., approximately 2.4 GHz) (e.g., graph 611). For the case where the substrate 590 is moved by 0.3 mm toward the conductive portion 410 (e.g., graph 612) and the case where it is moved relatively closer by 0.5 mm (e.g., graph 613), it can be seen that the radiation efficiency (e.g., gain) of the first antenna A1 is gradually decreases, thereby resulting in degraded radiation performance.

With reference to FIG. 7B, in an exemplary embodiment of the present disclosure where the substrate 590 is tiltedly disposed with respect to the conductive portion 410, the substrate 590 is spaced apart from the conductive portion 410 by a specific spacing distance such that the first antenna A1 does not affect the radiation performance of the second antenna A2 operating in a specific frequency band (e.g., approximately 2.4 GHz) (e.g., graph 614). For the case where a certain point of the substrate 590 is tilted to be closer by 0.3 mm toward the conductive portion 410 (e.g., graph 615) and the case where it is tilted relatively closer by 0.5 mm (e.g., graph 616), it can be seen that the decrease in radiation efficiency of the first antenna A1 is relatively small.

This may indicate that when the substrate 590 is tilted to gradually become closer to the conductive portion 410, it may help exhibit superior radiation performance of the first antenna A1 without reducing the radiation performance of the second antenna A2.

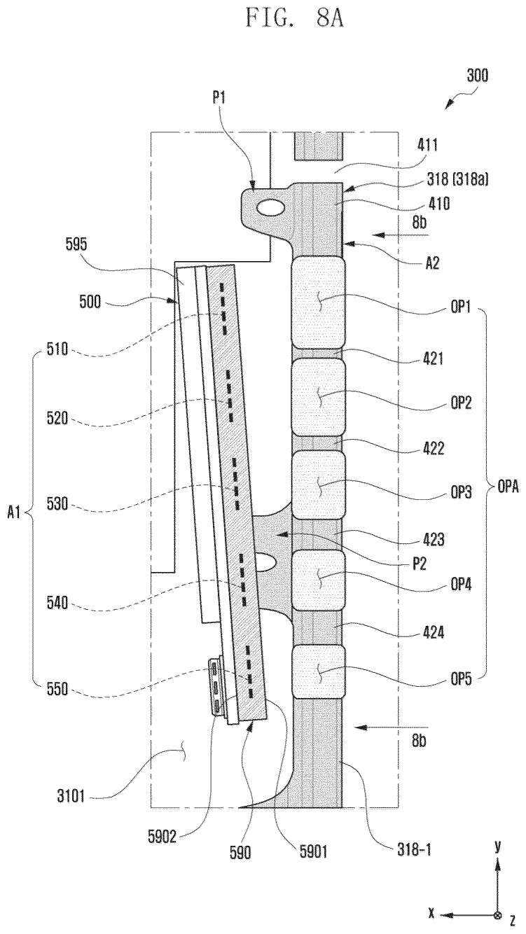

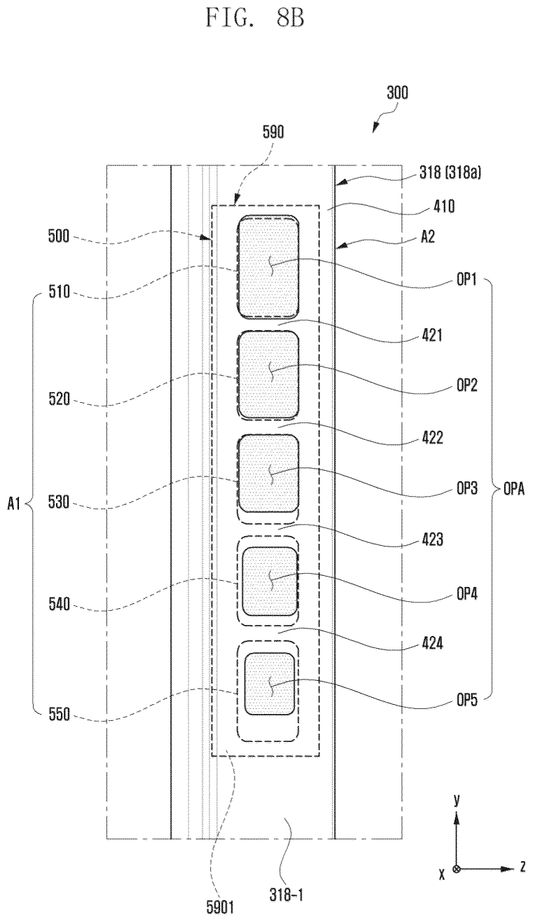

FIG. 8A is a partial configuration diagram of an electronic device including a tilted antenna module according to various embodiments of the present disclosure. FIG. 8B is a diagram of the electronic device viewed along a direction 8b-8b of FIG. 8A according to various embodiments of the present disclosure.

In describing the electronic device 300 of FIGS. 8A and 8B, the same reference numerals are assigned to constituent elements that are substantially the same as those of the electronic device 300 of FIGS. 5B and 5C, and detailed descriptions thereof may be omitted.

With reference to FIGS. 8A and 8B, the electronic device 300 may include the lateral member 318 including the conductive portion 410 that is segmented through the non-conductive portion 411 and includes a plurality of openings OP1, OP2, OP3, OP4, and OP5 that are spaced apart. In an embodiment, the electronic device 300 may include the antenna module 500 that is disposed in the internal space 3101, and includes the substrate 590 that is disposed in a tilted manner with respect to the conductive portion 410, and the plurality of antenna elements 510, 520, 530, 540, and 550 that are disposed on the substrate 590 so as to correspond at least partially to each of the plurality of openings OP1, OP2, OP3, OP4, and OP5. In an embodiment, the antenna module 500 may operate as the first antenna A1, and the conductive portion 410 may operate as the second antenna A2.

According to various embodiments, the plurality of openings OP1, OP2, OP3, OP4, and OP5 may be formed to have relatively smaller sizes as they becomes farther from the feeding point P1. In an embodiment, the plurality of openings OP1, OP2, OP3, OP4, and OP5 may be formed to have relatively smaller aperture ratios as they becomes farther from the feeding point P1. In an embodiment, the plurality of openings OP1, OP2, OP3, OP4, and OP5 may be formed to have larger sizes as they are closer to the feeding point P1. In such a case, the thickness of a second partition wall 422 between the second opening OP2 and the third opening OP3 may be formed to be thicker than the thickness of a first partition wall 421 between the first opening OP1 and the second opening OP2. Likewise, the thickness of a third partition wall 423 between the third opening OP3 and the fourth opening OP4 may be formed to be thicker than the thickness of the second partition wall 422 between the second opening OP2 and the third opening OP3. Likewise, the thickness of a fourth partition wall 424 between the fourth opening OP4 and the fifth opening OP5 may be formed to be thicker than the thickness of the third partition wall 423 between the third opening OP3 and the fourth opening OP4. For example, as the plurality of openings OP1, OP2, OP3, OP4, and OP5 are formed to have smaller sizes as they become farther from the feeding point P1, the partition walls 421, 422, 423, and 424 between the openings OP1, OP2, OP3, OP4, and OP5 may have relatively thicker thicknesses as they become farther from the feeding point P1, thereby helping to reinforce the rigidity of the electronic device 300.

<Table 3> below shows, in the N261 band (e.g., approximately 28 GHz), a cumulative distribution function (CDF) for each section of the first antenna A1 in case of a comparative example, in which the substrate 590 is disposed in parallel with the conductive portion 410, a case in which the substrate 590 is tilted with respect to the conductive portion 410 including the plurality of openings the same size (e.g., the plurality of openings OP1, OP2, OP3, OP4, and OP5 in FIG. 5C), and in case of an exemplary embodiment of the present disclosure, in which the substrate 590 is tilted with respect to the conductive portion 410 including the plurality of openings having different sizes (e.g., the plurality of openings OP1, OP2, OP3, OP4, and OP5 in FIG. 8A).

With reference to <Table 3> below, in the N261 band, it can be seen that the first antenna A1 exhibits relatively superior radiation performance in case in which the substrate 590 is tilted with respect to the conductive portion 410 including the plurality of openings having different sizes according to an exemplary embodiment of the present disclosure (e.g., the plurality of openings OP1, OP2, OP3, OP4, and OP5 in FIG. 8A), compared to a case in which the substrate 590 is disposed in parallel with the conductive portion 410 and a case in which the substrate 590 is tilted with respect to the conductive portion 410 including the plurality of openings having the same size (e.g., the plurality of openings OP1, OP2, OP3, OP4, and OP5 in FIG. 5C).

This may indicate that, as the plurality of openings (e.g., the plurality of openings OP1, OP2, OP3, OP4, and OP5 in FIG. 8A) are configured to have a relatively larger aperture ratio as they are closer to the feeding point P1, which is the feeding point of the conductive portion 410, it may help improve the radiation performance of the first antenna A1.

TABLE 3

| | N261 Simulation Results | | | | | | | | |
|---|---|---|---|---|---|---|---|---|---|
| | low(dB) | | | mid(dB) | | | high(dB) | | |
| CDF | 20% | 50% | Peak | 20% | 50% | Peak | 20% | 50% | Peak |
| Parallel disposition | −1.6 | 2.99 | 8.1 | −1.38 | 2.97 | 8.65 | −1.35 | 3.1 | 9.04 |
| Tilted disposition | −1.12 | 3.1 | 8.43 | −1.03 | 3.34 | 8.84 | −1.06 | 3.48 | 9.24 |
| Tilted disposition | −0.55 | 3.47 | 8.48 | −0.73 | 3.45 | 9.12 | −0.59 | 3.87 | 9.39 |
| opening variation | | | | | | | | | |

<Table 4> below shows, in the N260 band (e.g., approximately 39 GHz), a cumulative distribution function (CDF) for each section of the first antenna A1 in case of a comparative example, in which the substrate 590 is disposed in parallel with the conductive portion 410, in case in which the substrate 590 is tilted with respect to the conductive portion 410 including the plurality of openings having the same size (e.g., the plurality of openings OP1, OP2, OP3, OP4, and OP5 in FIG. 5C), and in case of an exemplary embodiment of the present disclosure, in which the substrate 590 is tilted with respect to the conductive portion 410 including the plurality of openings having different sizes (e.g., the plurality of openings OP1, OP2, OP3, OP4, and OP5 in FIG. 8A).

With reference to <Table 4> below, in the N260 band, it can be seen that the first antenna A1 exhibits relatively superior radiation performance in case in which the substrate 590 is tilted with respect to the conductive portion 410 including the plurality of openings having different sizes according to an exemplary embodiment of the present disclosure (e.g., the plurality of openings OP1, OP2, OP3, OP4, and OP5 in FIG. 8A), compared to a case in which the substrate 590 is disposed in parallel with the conductive portion 410 and a case in which the substrate 590 is tilted with respect to the conductive portion 410 including the plurality of openings having the same size (e.g., the plurality of openings OP1, OP2, OP3, OP4, and OP5 in FIG. 5C).

This may indicate that, as the plurality of openings (e.g., the plurality of openings OP1, OP2, OP3, OP4, and OP5 in FIG. 8A) are configured to have a relatively larger aperture ratio as they are closer to the feeding point P1, which is the feeding point of the conductive portion 410, it may help improve the radiation performance of the first antenna A1.

TABLE 4

| | N260 Simulation Results | | | | | | | | |
|---|---|---|---|---|---|---|---|---|---|
| | low(dB) | | | mid(dB) | | | high(dB) | | |
| CDF | 20% | 50% | Peak | 20% | 50% | Peak | 20% | 50% | Peak |
| Parallel disposition | −2.9 | 1.82 | 10.68 | −3.35 | 2.23 | 10.08 | −3.68 | 2.37 | 9.02 |
| Tilted disposition | −2.39 | 2.84 | 10.95 | −2.61 | 3.13 | 10.9 | −3.14 | 2.61 | 10.37 |
| Tilted disposition | −1.97 | 2.87 | 10.97 | −2.11 | 3.58 | 11.01 | −2.57 | 2.77 | 10.58 |
| opening variation | | | | | | | | | |

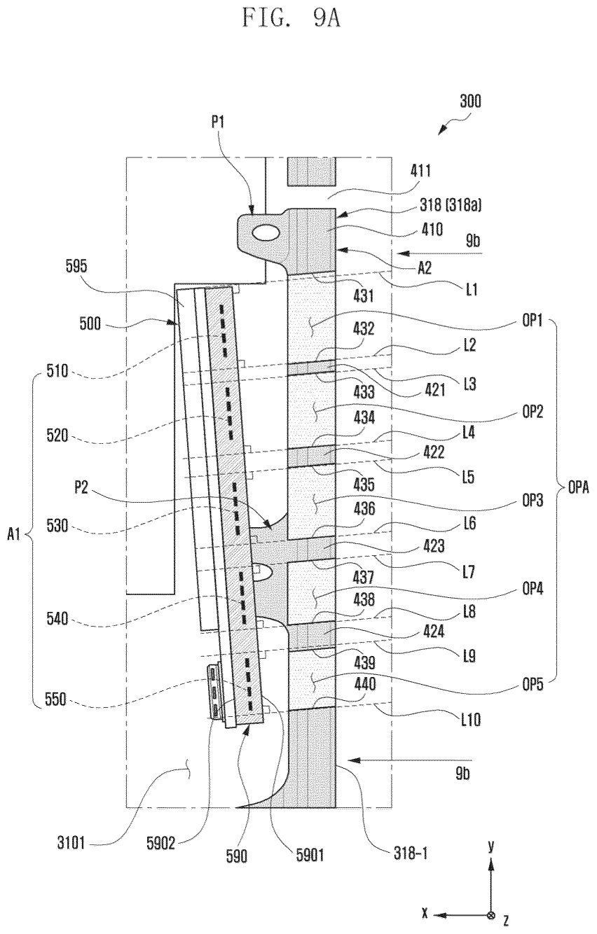

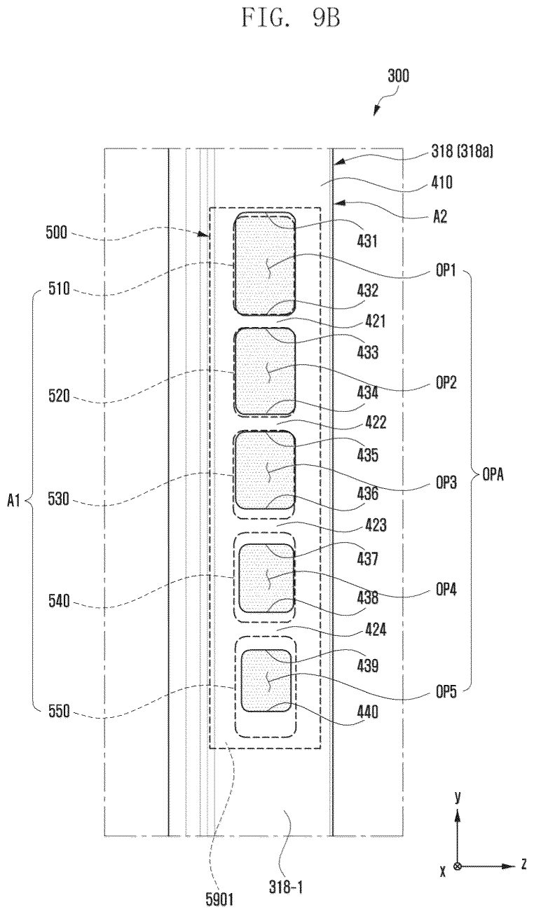

FIG. 9A is a partial configuration diagram of an electronic device including a tilted antenna module according to various embodiments of the present disclosure. FIG. 9B is a diagram of the electronic device viewed along a direction 9b-9b of FIG. 9A according to various embodiments of the present disclosure.

In describing the electronic device 300 of FIGS. 9A and 9B, the same reference numerals are assigned to constituent elements that are substantially the same as those of the electronic device 300 of FIGS. 8A and 8B, and detailed descriptions thereof may be omitted.

With reference to FIGS. 9A and 9B, the electronic device 300 may include the lateral member 318 including the conductive portion 410 that is segmented through the non-conductive portion 411 and includes a plurality of openings OP1, OP2, OP3, OP4, and OP5 that are spaced apart. In an embodiment, the electronic device 300 may include the antenna module 500 that is disposed in the internal space 3101, and includes the substrate 590 that is disposed in a tilted manner with respect to the conductive portion 410, and the plurality of antenna elements 510, 520, 530, 540, and 550 that are disposed on the substrate 590 so as to correspond at least partially to each of the plurality of openings OP1, OP2, OP3, OP4, and OP5. In an embodiment, the antenna module 500 may operate as the first antenna A1, and the conductive portion 410 may operate as the second antenna A2.

According to various embodiments, the plurality of openings OP1, OP2, OP3, OP4, and OP5 may be formed to have relatively smaller sizes as they becomes farther from the feeding point P1. In an embodiment, the plurality of openings OP1, OP2, OP3, OP4, and OP5 may be formed to have relatively smaller aperture ratios as they becomes farther from the feeding point P1. In an embodiment, the plurality of openings OP1, OP2, OP3, OP4, and OP5 may be formed to have larger sizes as they are closer to the feeding point P1. In this case, the partition walls 421, 422, 423, and 424 between the openings OP1, OP2, OP3, OP4, and OP5 may have relatively thicker thicknesses as they become farther from the feeding point P1, thereby helping to reinforce the rigidity of the electronic device 300.

According to various embodiments, inner surfaces of the plurality of openings OP1, OP2, OP3, OP4, and OP5 may be formed respectively as inclined surfaces 431, 432, 433, 434, 435, 436, 437, 438, 439, and 440 (e.g., inner surfaces) that are inclined at respective angles corresponding to imaginary lines L1, L2, L3, L4, L5, L6, L7, L8, L9, and L10 extending perpendicularly from the first substrate surface 5901 (e.g., with respect to an imaginary line). For example, the first opening OP1 may include a first inclined surface 431 and a second inclined surface 432 having respective angles corresponding to a first imaginary line L1 and a second imaginary line L2 extending perpendicularly from the corresponding position of the first substrate surface 5901. In an embodiment, the second opening OP2 may include a third inclined surface 433 and a fourth inclined surface 434 having respective angles corresponding to a third imaginary line L3 and a fourth imaginary line L4 extending perpendicularly from the corresponding position of the first substrate surface 5901. In an embodiment, the third opening OP3 may include a fifth inclined surface 435 and a sixth inclined surface 436 having respective angles corresponding to a fifth imaginary line L5 and a sixth imaginary line L6 extending perpendicularly from the corresponding position of the first substrate surface 5901. In an embodiment, the fourth opening OP4 may include a seventh inclined surface 437 and an eighth inclined surface 438 having respective angles corresponding to a seventh imaginary line L7 and an eighth imaginary line L8 extending perpendicularly from the corresponding position of the first substrate surface 5901. In an embodiment, the fifth opening OP5 may include a ninth inclined surface 439 and a tenth inclined surface 440 having respective angles corresponding to a ninth imaginary line L9 and a tenth imaginary line L10 extending perpendicularly from the corresponding position of the first substrate surface 5901.

For example, since the inner surfaces of the plurality of openings OP1, OP2, OP3, OP4, and OP5, which correspond to the plurality of antenna elements 510, 520, 530, 540, and 550, are formed as the inclined surfaces 431, 432, 433, 434, 435, 436, 437, 438, 439, and 440 respectively corresponding to the imaginary lines L1, L2, L3, L4, L5, L6, L7, L8, L9, and L10 perpendicular to the first substrate surface 5901, it may help improve radiation performance by reducing unnecessary reflections of a beam pattern.

<Table 5> below shows, in the N261 band (e.g., approximately 28 GHz), a cumulative distribution function (CDF) for each section of the first antenna A1, in case of a comparative example in which the substrate 590 is disposed in parallel with the conductive portion 410, in case in which the substrate 590 is tilted with respect to the conductive portion 410 that includes the plurality of openings having the same size (e.g., the plurality of openings OP1, OP2, OP3, OP4, and OP5 in FIG. 5C), in case in which the substrate 590 is tilted with respect to the conductive portion 410 that includes the plurality of openings having different sizes (e.g., the plurality of openings OP1, OP2, OP3, OP4, and OP5 in FIG. 8A), and in case in which the substrate 590 is tilted with respect to the conductive portion 410 that includes the plurality of openings having different sizes (e.g., the plurality of openings OP1, OP2, OP3, OP4, and OP5 in FIG. 9A) according to an exemplary embodiment of the present disclosure, the plurality of openings having inclined surfaces 431 to 440 respectively corresponding to imaginary lines L1 to L10 that are perpendicular to the first substrate surface 5901.

With reference to <Table 5> below, it can be seen that, in the N261 band, the first antenna A1 exhibits relatively superior radiation performance in case in which the substrate 590 is tilted with respect to the conductive portion 410 that includes the plurality of openings having different sizes (e.g., the plurality of openings OP1, OP2, OP3, OP4, and OP5 in FIG. 9A) according to an exemplary embodiment of the present disclosure and the plurality of openings having inclined surfaces 431 to 440 respectively corresponding to the imaginary lines L1 to L10 perpendicular to the first substrate surface 5901, compared to the case in which the substrate 590 is disposed in parallel with the conductive portion 410, the case in which the substrate 590 is tilted with respect to the conductive portion 410 that includes the plurality of openings having the same size (e.g., the plurality of openings OP1, OP2, OP3, OP4, and OP5 in FIG. 5C), and the case in which the substrate 590 is tilted with respect to the conductive portion 410 that includes the plurality of openings having different sizes (e.g., the plurality of openings OP1, OP2, OP3, OP4, and OP5 in FIG. 8A).

This may indicate that the plurality of openings (e.g., the plurality of openings OP1, OP2, OP3, OP4, and OP5 in FIG. 9A) are configured such that the aperture ratios are relatively large as they are closer to the feeding point P1, which is the feeding point of the conductive portion 410, and they have the inclined surfaces 431 to 440 respectively corresponding to the imaginary lines L1 to L10 perpendicular to the first substrate surface 5901, thereby helping to improve the radiation performance of the first antenna A1.

TABLE 5

| | N261 Simulation Results | | | | | | | | |
|---|---|---|---|---|---|---|---|---|---|
| | low(dB) | | | mid(dB) | | | high(dB) | | |
| CDF | 20% | 50% | Peak | 20% | 50% | Peak | 20% | 50% | Peak |
| Parallel disposition | −1.6 | 2.99 | 8.1 | −1.38 | 2.97 | 8.65 | −1.35 | 3.1 | 9.04 |
| Tilted disposition | −1.12 | 3.1 | 8.43 | −1.03 | 3.34 | 8.84 | −1.06 | 3.48 | 9.24 |
| Tilted disposition | −0.55 | 3.47 | 8.48 | −0.73 | 3.45 | 9.12 | −0.59 | 3.87 | 9.39 |
| opening variation | | | | | | | | | |
| Tilted disposition | −0.51 | 3.81 | 8.57 | 0.11 | 3.79 | 9.25 | 0.67 | 3.89 | 9.45 |
| opening variation | | | | | | | | | |
| inclined surface | | | | | | | | | |
| formation | | | | | | | | | |

<Table 6> below shows, in the N260 band (e.g., approximately 39 GHz), a cumulative distribution function (CDF) for each section of the first antenna A1, in case of a comparative example in which the substrate 590 is disposed in parallel with the conductive portion 410, in case in which the substrate 590 is tilted with respect to the conductive portion 410 that includes the plurality of openings having the same size (e.g., the plurality of openings OP1, OP2, OP3, OP4, and OP5 in FIG. 5C), in case in which the substrate 590 is tilted with respect to the conductive portion 410 that includes the plurality of openings having different sizes (e.g., the plurality of openings OP1, OP2, OP3, OP4, and OP5 in FIG. 8A), and in case in which the substrate 590 is tilted with respect to the conductive portion 410 that includes the plurality of openings having different sizes (e.g., the plurality of openings OP1, OP2, OP3, OP4, and OP5 in FIG. 9A) according to an exemplary embodiment of the present disclosure, the plurality of openings having inclined surfaces 431 to 440 respectively corresponding to imaginary lines L1 to L10 that are perpendicular to the first substrate surface 5901.

With reference to <Table 6> below, it can be seen that, in the N261 band, the first antenna A1 exhibits relatively superior radiation performance in case in which the substrate 590 is tilted with respect to the conductive portion 410 that includes the plurality of openings having different sizes (e.g., the plurality of openings OP1, OP2, OP3, OP4, and OP5 in FIG. 9A) according to an exemplary embodiment of the present disclosure and the plurality of openings having inclined surfaces 431 to 440 respectively corresponding to the imaginary lines L1 to L10 perpendicular to the first substrate surface 5901, compared to the case in which the substrate 590 is disposed in parallel with the conductive portion 410, the case in which the substrate 590 is tilted with respect to the conductive portion 410 that includes the plurality of openings having the same size (e.g., the plurality of openings OP1, OP2, OP3, OP4, and OP5 in FIG. 5C), and the case in which the substrate 590 is tilted with respect to the conductive portion 410 that includes the plurality of openings having different sizes (e.g., the plurality of openings OP1, OP2, OP3, OP4, and OP5 in FIG. 8A).

This may indicate that the plurality of openings (e.g., the plurality of openings OP1, OP2, OP3, OP4, and OP5 in FIG. 9A) are configured such that the aperture ratios are relatively large as they are closer to the feeding point P1, which is the feeding point of the conductive portion 410, and they have the inclined surfaces 431 to 440 respectively corresponding to the imaginary lines L1 to L10 perpendicular to the first substrate surface 5901, thereby helping to improve the radiation performance of the first antenna A1.

TABLE 6

| | N260 Simulation Results | | | | | | | | |
|---|---|---|---|---|---|---|---|---|---|
| | low(dB) | | | mid(dB) | | | high(dB) | | |
| CDF | 20% | 50% | Peak | 20% | 50% | Peak | 20% | 50% | Peak |
| Parallel disposition | −2.9 | 1.82 | 10.68 | −3.35 | 2.23 | 10.08 | −3.68 | 2.37 | 9.02 |
| Tilted disposition | −2.39 | 2.84 | 10.95 | −2.61 | 3.13 | 10.9 | −3.14 | 2.61 | 10.37 |
| Tilted disposition | −1.97 | 2.87 | 10.97 | −2.11 | 3.58 | 11.01 | −2.57 | 2.77 | 10.58 |
| opening variation | | | | | | | | | |
| Tilted disposition | 0.33 | 3.08 | 11.54 | −0.31 | 3.98 | 12.7 | 0.31 | 3.24 | 10.99 |
| opening variation | | | | | | | | | |
| inclined surface | | | | | | | | | |
| formation | | | | | | | | | |

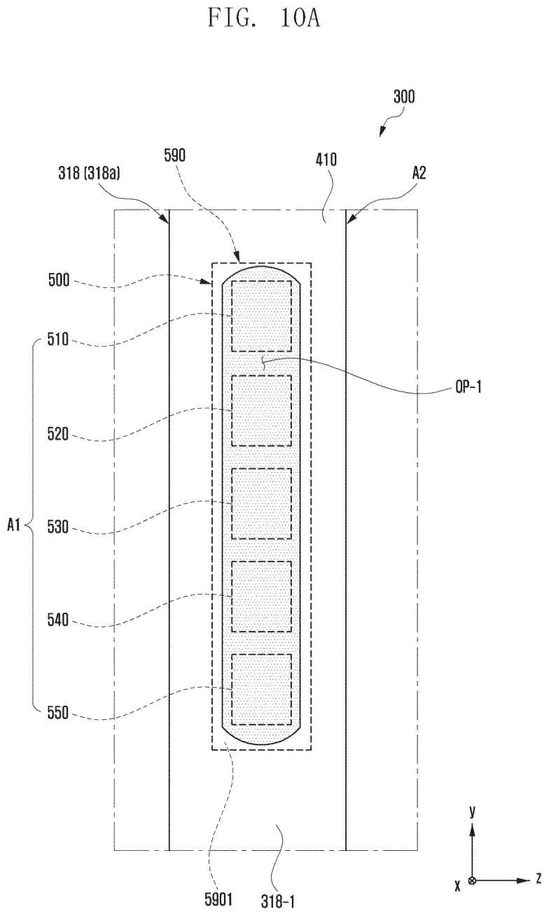

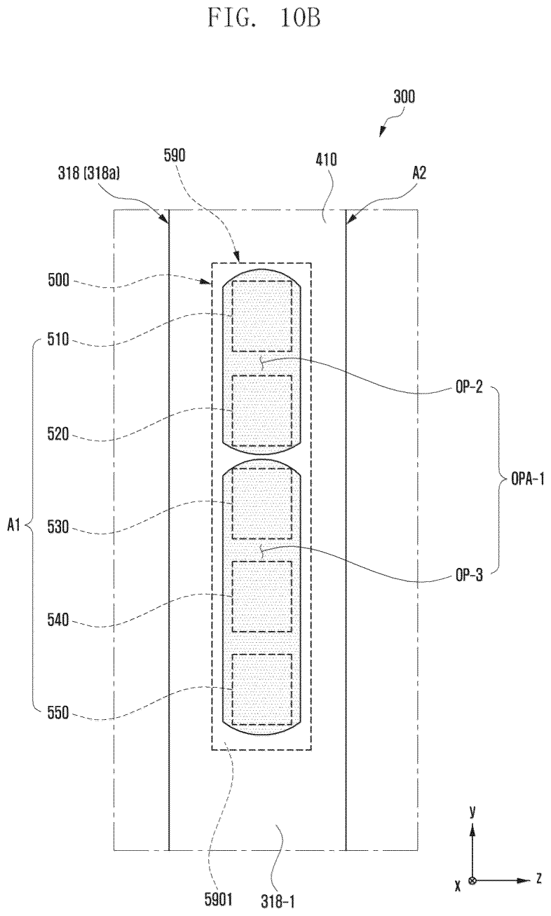

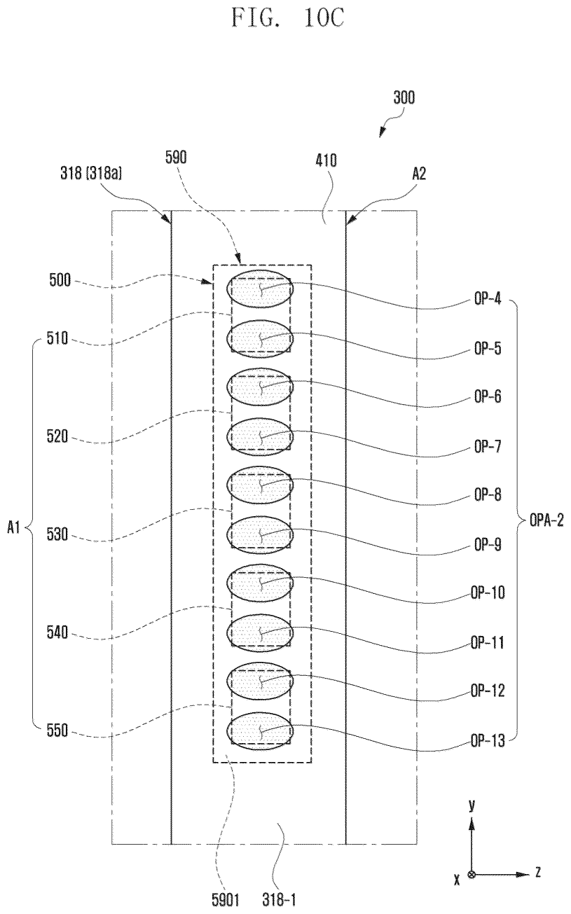

FIGS. 10A to 10C are diagrams illustrating a disposition structure of a first antenna and a second antenna according to various embodiments of the present disclosure.

In describing the electronic device 300 of FIGS. 10A to 10C, the constituent elements that are substantially identical to the electronic device 300 of FIG. 5C are assigned the same reference numerals, and a detailed description thereof may be omitted.

With reference to FIGS. 10A to 10C, the electronic device 300 may include the lateral member 318 including the conductive portion 410 including at least one opening OP-1, OPA-1, and OPA-2. In an embodiment, the electronic device 300 may include an antenna module 500 that includes the substrate 590 disposed in the internal space 3101 and disposed in a manner tilted with respect to the conductive portion 410, and a plurality of antenna elements 510, 520, 530, 540, and 550 disposed at least partially to correspond to at least one opening OP-1, OPA-1, and OPA-2 in the substrate 590. In an embodiment, the antenna module 500 may operate as the first antenna A1, and the conductive portion 410 may operate as the second antenna A2.

With reference to FIG. 10A, when the lateral member 318 is viewed from the outside (e.g., when the lateral member 318 is viewed in a direction perpendicular from the outside), at least one opening OP-1 may be disposed to overlap the plurality of antenna elements 510, 520, 530, 540, and 550. According to an embodiment, at least one opening OP-1 may include one opening OP-1 disposed to overlap all of the plurality of antenna elements 510, 520, 530, 540, and 550.

With reference to FIG. 10B, when the lateral member 318 is viewed from the outside (e.g., when the lateral member 318 is viewed in a direction perpendicular from the outside), at least one opening OPA-1 may be disposed to overlap the plurality of antenna elements 510, 520, 530, 540, and 550. According to an embodiment, at least one opening OPA-1 may include a first opening OP-2, which is disposed to overlap the first antenna element 510 and the second antenna element 520 and a second opening OP-2, which is disposed to overlap the third antenna element 530, the fourth antenna element 540, and the fifth antenna element 550, among the plurality of antenna elements 510, 520, 530, 540, and 550.

With reference to FIG. 10C, when the lateral member 318 is viewed from the outside (e.g., when the lateral member 318 is viewed in a direction perpendicular from the outside), at least one opening OPA-2 may be disposed to overlap the plurality of antenna elements 510, 520, 530, 540, and 550. According to an embodiment, at least one opening OPA-2 may include: a first opening OP-4 and a second opening OP-5, which are disposed to overlap the first antenna element 510; a third opening OP-6 and a fourth opening OP-7, which are disposed to overlap the second antenna element 520; a fifth opening OP-8 and a sixth opening OP-9, which are disposed to overlap the third antenna element 530; a seventh opening OP-10 and an eighth opening OP-11, which are disposed to overlap the fourth antenna element 540; and a ninth opening OP-12 and a tenth opening OP-13, which are disposed to overlap the fifth antenna element 550, among the plurality of antenna elements 510, 520, 530, 540, and 550.

According to various embodiments, an electronic device may include: a housing (e.g., the housing 310 in FIG. 3A) including a conductive portion (e.g., the conductive portion 410 in FIG. 4) that forms at least a portion of a side surface (e.g., the first side surface 318-1 in FIG. 3C) and includes at least one opening (e.g., the openings OPA in FIG. 4); an antenna module that is disposed in the housing and includes a substrate (e.g., the substrate 590 in FIG. 4) including a first substrate surface (e.g., the first substrate surface 5901 in FIG. 4) and a plurality of antenna elements (e.g., the antenna elements 510, 520, 530, 540, and 550 in FIG. 4) disposed on the substrate to form a beam pattern in a direction in which the first substrate surface faces, the substrate being disposed such that the first substrate surface faces the conductive portion, so that a portion of the beam pattern formed by the plurality of antenna elements extends in a direction passing through the at least one opening; a first wireless communication circuit (e.g., the wireless communication circuit 595 in FIG. 4) configured to transmit and/or receive a wireless signal in at least one first frequency band through the antenna module; and a second wireless communication circuit electrically connected to a feeding point of the conductive portion and configured to transmit and/or receive a wireless signal in at least one second frequency band through the conductive portion, in which the substrate may be tilted so as not to be parallel to an inner surface (e.g., the inner surface 318d in FIG. 4) of the conductive portion.

According to various embodiments, the substrate may be tilted such that a first distance between the feeding point of the conductive portion and the substrate is greater than a second distance between a ground point P2 of the conductive portion and the substrate.

According to various embodiments, the first distance may be set to be greater than 2 mm.

According to various embodiments, a maximum proximity distance (e.g., distance d1 in FIG. 5B) between an antenna element among the plurality of antenna elements, which is disposed closest to the conductive portion, and the conductive portion may be determined in a range of 0.05 mm to 0.3 mm.

According to various embodiments, a spacing distance (e.g., distance d2 in FIG. 5B) between an antenna element among the plurality of antenna elements, which is disposed farthest from the conductive portion, and the conductive portion may be 2.5 mm or more.

According to various embodiments, the housing may include: a front surface cover (e.g., the front surface cover 302 in FIG. 3C), a rear surface cover (e.g., the rear surface cover 311 in FIG. 3C) facing a direction opposite to the front surface cover, and a lateral member (e.g., the lateral member 318 in FIG. 3C) disposed between the front surface cover and the rear surface cover, and the conductive portion may be included in at least a portion of the lateral member.

According to various embodiments, the substrate may be disposed such that the first substrate surface is located perpendicular to the front surface cover and/or the rear surface cover.

According to various embodiments, the lateral member may include an extension member (e.g., the extension member 3181 in FIG. 3C) extending into an interior of the housing, and the extension member may include a recess for accommodating at least a portion of the substrate, and the substrate may be tilted by the recess.

According to various embodiments, the at least one opening may include a first opening and a second opening that are disposed to at least partially overlap the plurality of antenna elements when viewed in a direction perpendicular to the side surface.

According to various embodiments, the first opening (e.g., the first opening OP1 in FIG. 8A) and the second opening (e.g., the fifth opening OP5 in FIG. 8A) may have different opening sizes such that the first opening, which is closest to the feeding point, is larger than the second opening, which is farthest from the feeding point.

According to various embodiments, each of the plurality of openings (e.g., the openings OP1, OP2, OP3, OP4, and OP5 in FIG. 9A) may include an inner surface (e.g., the inclined surfaces 431 to 440 in FIG. 9A) inclined at an angle with respect to an imaginary line extending perpendicularly from the first substrate surface.

According to various embodiments, the at least one opening may include one opening (e.g., the opening OP-1 in FIG. 10A) that is disposed to overlap the plurality of antenna elements when the side surface is viewed from the outside.

According to various embodiments, the at least one opening may be disposed such that at least two of the plurality of antenna elements overlap one opening (e.g., the openings OPA-1 in FIG. 10B) when the side surface is viewed from the outside.

According to various embodiments, the at least one opening may include a plurality of openings (e.g., the openings OPA-2 in FIG. 10C) that are disposed spaced apart to overlap one antenna element of the plurality of antenna elements, when the side surface is viewed from the outside.

According to various embodiments, the at least one opening may be filled with a non-conductive member (e.g., the non-conductive member 318b in FIG. 4).

According to various embodiments, the housing may include a conductive lateral member, and the conductive portion may be electrically segmented through at least one non-conductive portion (e.g., the non-conductive portion 411 in FIG. 4), and the at least one non-conductive portion may be formed through an extension of the non-conductive member.

According to various embodiments, the substrate may include a second substrate surface (e.g., the second substrate surface 5902 in FIG. 4) facing in a direction opposite to the first substrate surface, and the first wireless communication circuit may be disposed on the second substrate surface.

According to various embodiments, the at least one antenna element may include a plurality of conductive patches that are exposed on the first substrate surface or inside the substrate and disposed spaced apart from each other.

According to various embodiments, the housing may include a printed circuit board disposed in an internal space thereof (e.g., the printed circuit board 340 in FIG. 5A), and the second wireless communication circuit may be disposed on the printed circuit board.

According to various embodiments, the conductive portion may be electrically connected to a ground (e.g., the ground G in FIG. 5B) of the printed circuit board through a ground point (e.g., the ground point P2 in FIG. 5B) spaced apart from the feeding point.

Further, the embodiments of the present disclosure disclosed in the present specification and illustrated in the drawings are provided as particular examples for easily explaining the technical contents according to the embodiment of the present disclosure and helping understand the embodiment of the present disclosure, but not intended to limit the scope of the embodiment of the present disclosure. Accordingly, the scope of the various embodiments of the present disclosure should be interpreted as including all alterations or modifications derived from the technical spirit of the various embodiments of the present disclosure in addition to the disclosed embodiments.

What is claimed is:

1. An electronic device comprising:
a housing comprising a conductive portion that forms at least a portion of a side surface of the housing, the conductive portion comprising at least one opening;
an antenna module in the housing, the antenna module comprising:
a substrate comprising a first substrate surface; and
a plurality of antenna elements disposed at the substrate and configured to form a beam pattern in a direction in which the first substrate surface faces, wherein the first substrate surface of the substrate faces the conductive portion so that a portion of the beam pattern formed by the plurality of antenna elements extends in a direction that passes through the at least one opening;
a first wireless communication circuit configured to transmit or receive a wireless signal in at least one first frequency band through the antenna module; and
a second wireless communication circuit electrically connected to a feeding point of the conductive portion and configured to transmit or receive a wireless signal in at least one second frequency band through the conductive portion,
wherein the substrate is tilted with respect to the conductive portion so that the first substrate surface of the substrate and an inner surface of the conductive portion are not parallel to each other.

2. The electronic device of claim 1, wherein the substrate is tilted such that a first distance between the feeding point of the conductive portion and the substrate is greater than a second distance between a ground point of the conductive portion and the substrate.

3. The electronic device of claim 2, wherein the first distance is greater than 2 mm.

4. The electronic device of claim 1, wherein a maximum proximity distance between an antenna element of the plurality of antenna elements that is closest to the conductive portion and the conductive portion is in a range of 0.05 mm to 0.3 mm.

5. The electronic device of claim 1, wherein a distance between an antenna element of the plurality of antenna elements that is farthest from the conductive portion and the conductive portion is greater than or equal to 2.5 mm.

6. The electronic device of claim 1, wherein the housing further comprises:
a front surface cover;
a rear surface cover facing a direction opposite to the front surface cover; and
a lateral member between the front surface cover and the rear surface cover, and
wherein the conductive portion is included in at least a portion of the lateral member.

7. The electronic device of claim 6, wherein the substrate is disposed such that the first substrate surface is perpendicular to at least one of the front surface cover or the rear surface cover.

8. The electronic device of claim 6, wherein the lateral member comprises an extension member extending into an interior of the housing, and
wherein the extension member comprises a recess configured to accommodate at least a portion of the substrate, and the substrate is tilted by the recess.

9. The electronic device of claim 1, wherein the at least one opening comprises a first opening and a second opening that at least partially overlap the plurality of antenna elements when viewed in a direction perpendicular to the side surface.

10. The electronic device of claim 9, wherein the first opening is closest to the feeding point and has a first size, and the second opening is farthest from the feeding point and has a second size that is smaller than the first size.

11. The electronic device of claim 9, wherein each of the first opening and the second opening comprises an inner surface that is inclined at an angle with respect to an imaginary line extending perpendicularly from the first substrate surface.

12. The electronic device of claim 1, wherein the at least one opening comprises an opening that overlaps the plurality of antenna elements when the side surface is viewed from an outside.

13. The electronic device of claim 1, wherein the at least one opening comprises an opening that overlaps at least two antenna elements of the plurality of antenna elements when the side surface is viewed from an outside.

14. The electronic device of claim 1, wherein the at least one opening comprises a plurality of openings that are spaced apart from each other and overlap one antenna element of the plurality of antenna elements when the side surface is viewed from an outside.

15. The electronic device of claim 1, wherein the housing further comprises a non-conductive member filling the at least one opening.

16. The electronic device of claim 15, wherein the housing further comprises a conductive lateral member, and at least one non-conductive portion that electrically segments the conductive portion.

17. The electronic device of claim 1, wherein the substrate further comprises a second substrate surface opposite to the first substrate surface, and the first wireless communication circuit is disposed on the second substrate surface.

18. The electronic device of claim 1, wherein the plurality of antenna elements comprises a plurality of conductive patches that are spaced apart from each other and are exposed on the first substrate surface or inside the substrate.

19. The electronic device of claim 1, further comprising a printed circuit board disposed in an internal space of the housing,
wherein the second wireless communication circuit is disposed on the printed circuit board.

20. The electronic device of claim 19, wherein the conductive portion is electrically connected to a ground of the printed circuit board through a ground point that is spaced apart from the feeding point.
